(19) United States
(12) Patent Application Publication
(10) Pub. No.: US 2006/0064236 A1
(43) Pub. Date: Mar. 23, 2006

(54) System and apparatus for road traffic congestion degree estimation

(75) Inventor: Kazumi Hayashi, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/231,080

(22) Filed: Sep. 20, 2005

(30) Foreign Application Priority Data
Sep. 21, 2004 (JP) 2004-273400

(51) Int. Cl. G08G 1/00

(52) U.S. Cl. 701/117; 701/200

(57) ABSTRACT

A road traffic congestion degree estimation system includes smart plate readers that detect vehicles driven on a general road externally leading to a resort. The numbers of local vehicles and strange vehicles that currently exist in the resort are calculated, based on the number of vehicles approaching the resort, the number of vehicles receding from the resort, and information of smart plates of the detected vehicles. Furthermore, a prospective degree of traffic congestion on an expressway, which introduces the strange vehicles receding from the resort via the general road into areas where the strange vehicles are based, is estimated based on the above calculated numbers of local vehicles and strange vehicles. In this estimation, the number of strange vehicles contributes more greatly to an increase in the degree of traffic congestion than the number of local vehicles does.

### CROSS REFERENCE TO RELATED APPLICATIONS

This application is based on and incorporates herein by reference Japanese Patent Application No. 2004-273400 filed on Sep. 21, 2004.

### FIELD OF THE INVENTION

The present invention relates to a road traffic congestion degree estimation system and a road traffic congestion degree estimation apparatus.

### BACKGROUND OF THE INVENTION

An information-on-road traffic jam provision system based on a vehicle information and communication system (VICS) that adopts an FM multiplex technique or a beacon technique has been known these days.

Patent Document 1 discloses a technology of predicting a traffic jam on a road by acquiring information on a number plate (or license plate) through radio-communication with each vehicle via an on-road machine, and detecting a probable destination of the vehicle on the basis of information on a place name contained in the information on the number plate.

Patent Document 1: JP-2003-109169A

The above patent document describes that a place name contained in the information on a number plate is recognized as a destination but does not describe how to predict a traffic jam on a road.

### SUMMARY OF THE INVENTION

Accordingly, an object of the present invention is to provide a system or apparatus for estimating the extent of traffic congestion on a road on the basis of information on vehicles that are driven on the road.

The present invention is based on an idea that in a case, for instance, only one general road connects an expressway and a resort (or any other area), the numbers of vehicles existing in a nearby area including the resort and the prospective extent of traffic congestion on the expressway leading to the outside of the nearby area correlate with one another. Here, the numbers of vehicles are, more particularly, the number of local vehicles that are basically used within the nearby area including the resort and the number of strange vehicles other than the local vehicles.

To achieve above object of the present invention, a road traffic congestion degree estimation system is provided with the following: Vehicle sensing means is included for detecting a vehicle which is driven on a first road extending between a first area and an outside of the first area. Calculating means is included for calculating (i) a number of local vehicles that are based in a second area including the first area and that currently exist in the first area and (ii) a number of strange vehicles that are based in an outside of the second area and currently exist in the first area, based on a number of approaching vehicles driven in a direction of approaching the first area and a number of receding vehicles driven on the first road in a direction of receding from the first area, wherein the number of approaching vehicles and the number of receding vehicles are included in a number of vehicles detected by the vehicle sensing means. Estimating means is included for estimating a prospective degree of traffic congestion on a second road, which extends from the second area to the outside of the second area and introduces a vehicle coming from the first area into the outside of the second area, based on the calculated number of strange vehicles and the calculated number of local vehicles, wherein the number of strange vehicles contributes more greatly to an increase in the degree of traffic congestion than the number of local vehicles contributes. Furthermore, storage control means is included for storing data, which specifies the estimated degree of traffic congestion, in a storage medium.

A road traffic congestion degree estimation system can estimate a degree of traffic congestion on a second road (e.g., expressway) that introduces vehicles coming from a first area (e.g., resort) to the outside of a second area (e.g., nearby area including the resort) on the basis of the numbers of local vehicles and strange vehicles existing within the first area. The estimation is achieved based on the idea that the strange vehicles contribute more greatly to the prospective degree of traffic congestion on the second road than the local vehicles do.

### BRIEF DESCRIPTION OF THE DRAWINGS

The above and other objects, features, and advantages of the present invention will become more apparent from the following detailed description made with reference to the accompanying drawings. In the drawings:

FIG. 1 schematically shows a resort where a road traffic congestion degree estimation system in accordance with a first embodiment of the present invention is installed, and its surroundings;

FIG. 2 is a side view of part of a general road showing the positional relationships among smart plate readers and a vehicle driven on the general road 2;

FIG. 3 shows a position on a number plate at which a smart plate is disposed;

FIG. 4 shows the hardware configuration of the smart plate;

FIG. 5 shows the hardware configuration of the smart plate readers;

FIG. 6 shows the hardware configuration of a server;

FIG. 7 is a flowchart describing a number-of-vehicles count program to be run by a control unit included in the server;

FIG. 8 is a table listing the meanings of variables A to D;

FIG. 9 is a flowchart describing a degree-of-traffic congestion estimation program to be run by the control unit included in the server;

FIG. 10 is a table listing the meanings of coefficients α(t), β(t), and γ(t) employed in estimation of a degree of traffic congestion;

FIG. 11 is a table listing expressions for use in calculating degrees of traffic congestions on respective roads;

FIG. 12 is a graph showing an example of a graph of a function of the coefficient α(t);

FIG. 13 is a graph showing an example of a graph of a function of the coefficient β(t);

FIG. 14 is a graph showing an example of a graph of a function of the coefficient γ(t);

FIG. 15 shows an example of a display image showing an estimated extent of traffic congestion on a road;

FIG. 16 is a side view of part of a general road employed in a second embodiment;

FIG. 17 shows the hardware configuration of a DSRC on-road machine;

FIG. 18 is a flowchart describing a number-of-vehicles count program to be run by a control unit included in a server;

FIG. 19 is a side view of part of a general road employed in a third embodiment;

FIG. 20 shows the hardware configuration of a composite on-road machine;

FIG. 21 is a side view of part of a general road employed in a fourth embodiment;

FIG. 22 shows the hardware configuration of an ETC on-road machine;

FIG. 23 is a flowchart describing a number-of-vehicles count program to be run by a control unit included in a server;

FIG. 24 is a bird's-eye view of an accommodation facility employed in a fifth embodiment;

FIG. 25 is a flowchart describing a number-of-guests' vehicles count program to be run by a control unit included in a server;

FIG. 26 is a table listing the meanings of variables B′ to D′;

FIG. 27 is a table listing expressions for use in calculating degrees of traffic congestions on respective roads;

FIG. 28 shows a tag-incorporated key used in a sixth embodiment;

FIG. 29 shows a key, a key ring, and a tag-incorporated key holder;

FIG. 30 shows a tag-incorporated smart key;

FIG. 31 shows the hardware configuration of a tag reader;

FIG. 32 is a flowchart describing a number-of-guests' vehicles count program to be run by the control unit included in the server;

FIG. 33 is a conceptual diagram showing a road traffic congestion degree estimation system in accordance with a seventh embodiment;

FIG. 34 is a flowchart describing a number-of-guests' vehicles count program to be run by a control unit included in a server;

FIG. 35 schematically shows a resort where a road traffic congestion degree estimation system in accordance with an eighth embodiment is installed, and its surroundings;

FIG. 36 is a table listing the meanings of variables A to D employed in the eighth embodiment;

FIG. 37 is a table listing the meanings of variables A1 to D1 employed in the eighth embodiment;

FIG. 38 is a table listing the meanings of variables A45 to D45 employed in the eighth embodiment;

FIG. 39 is a table listing the meanings of coefficients α(t) to δ(t) employed in the eighth embodiment;

FIG. 40 is a table listing expressions for use in calculating degrees of traffic congestions on respective roads employed in the eighth embodiment;

FIG. 41 is a table listing expressions for use in calculating degrees of traffic congestions on respective roads according to a ninth embodiment;

FIG. 42 shows the hardware configuration of a car navigation system employed in a tenth embodiment;

FIG. 43 is a flowchart describing a navigation program to be run by a control unit included in the car navigation system;

FIG. 44 shows an example of a display image presenting a degree of road traffic congestion which is displayed on an image display device included in the car navigation system;

FIG. 45 shows an example of the display image presenting a degree of road traffic congestion which is displayed on the image display device included in the car navigation system; and

FIG. 46 shows an example of the display image presenting a degree of road traffic congestion which is displayed on the image display device included in the car navigation system.

### DESCRIPTION OF THE PREFERRED EMBODIMENTS

### FIRST EMBODIMENT

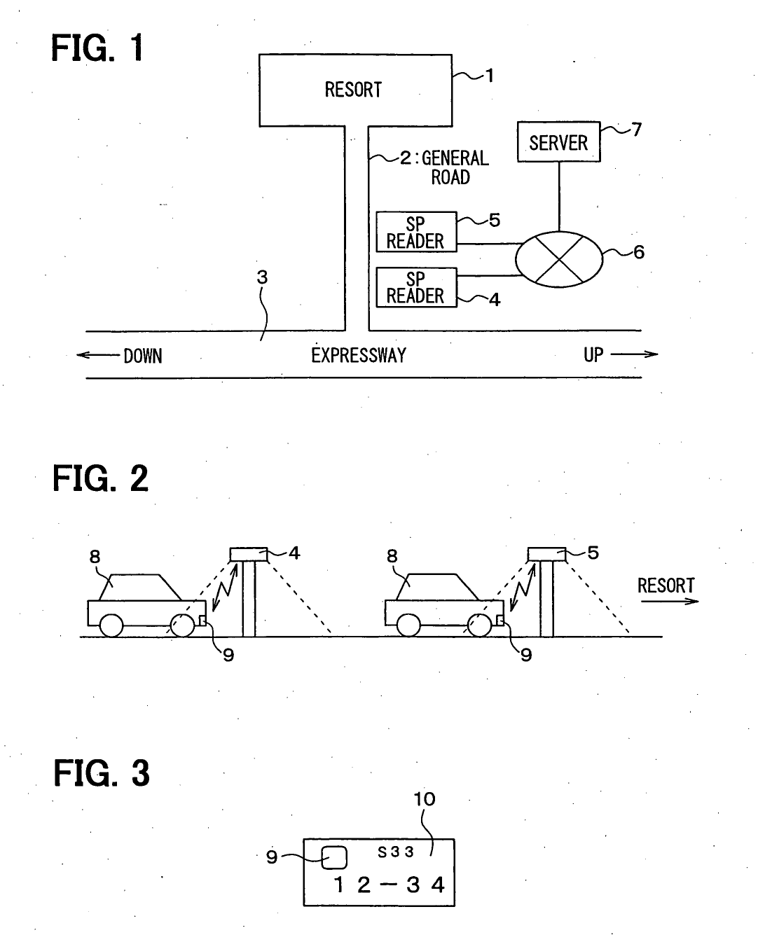

An embodiment of the present invention will be described below. FIG. 1 schematically shows a resort 1 as a first area where a road traffic congestion degree estimation system in accordance with the present embodiment is installed, and its surroundings. A general road 2 as a first road extending from the resort 1 to the outside allows people to come to the resort 1 from the outside or go from the resort 1 to the outside. Unless a vehicle is driven through the general road 2, the vehicle cannot be shuttled between the resort 1 and the outside. Moreover, the general road 2 leads to an expressway 3 as a second road. The expressway 3 extends from the resort 1 and a nearby area near the resort 1, as a second area (e.g., an area within the prefecture that the resort 1 belongs to), to the outside of the nearby area. People therefore use the expressway 3 to travel from the resort 1 to the outside of the nearby area. As the resort 1 that is geographically closed except the presence of one road extending therefrom, for example, a ski resort or a racing circuit is conceivable.

When a large number of vehicles visits the resort 1 from far away for the purpose of leisure activities, the number of vehicles within the resort 1 correlates with the degree of traffic congestion on the expressway 3. Namely, the larger the number of vehicles within the resort 1 at a certain time instant is, the greater the traffic volume on the expressway 3 at a subsequent time instant is. The degree of traffic congestion on the expressway thereby tends to increase. Moreover, the degree of traffic congestion on the expressway 3 is affected more greatly by the number of strange vehicles, which are based in remote places and have come from the remote places, than by the number of local vehicles that are based on the area near the resort 1 and basically driven in the area near the resort 1.

Moreover, a ratio is defined to be of, among the strange vehicles existing in the resort 1, the number of strange vehicles driven on the up lane of the expressway 3 to the number of strange vehicles driven on the down lane of the expressway 3. This ratio affects the difference between the degree of traffic congestion on the up lane of the expressway 3 at a subsequent time instant and the degree of traffic congestion on the down lane thereof at the subsequent time instant.

According to the present embodiment, from the foregoing aspects, the road traffic congestion degree estimation system estimates the degree of traffic congestion on the expressway 3 at a subsequent time instant according to the number of vehicles existing in the resort 1. Furthermore, the estimation is achieved so that the number of strange vehicles existing in the resort 1 will contribute more greatly to the degree of traffic congestion than the number of local vehicles does.

The road traffic congestion degree estimation system comprises two smart plate readers 4 and 5 as vehicle sensors (SP readers in FIG. 1) installed on a roadside of the general road 2 and a server 7 as a road traffic congestion degree estimation apparatus connected to the smart plate readers 4 and 5 over a network 6. The network 6 may be a wide-area network such as the Internet or a local-area network (LAN) dedicated to the road traffic congestion degree estimation system.

FIG. 2 is a side view of part of the general road 2 showing the positional relationship among the smart plate readers 4 and 5 and a vehicle 8 driven on the general road 2. The smart plate readers 4 and 5 are, as described later, installed so that the smart plate readers 4 and 5 will communicate by radio with a smart plate 9 embedded in a number plate 10 of the vehicle 8. Namely, the radio-communication enabled zones in which the smart plate readers 4 and 5 can communicate with the smart plate 9 by radio will cover both a lane of the general road 2 that allows vehicles to approach the resort 1, and a lane thereof that allows vehicles to recede from the resort 1. Consequently, the smart plate readers 4 and 5 can detect both vehicles that are driven on the general road 2 in a direction of approaching the resort 1, and vehicles that are driven on the general road 2 in a direction of receding from the resort 1. Moreover, the smart plate reader 4 is installed at a position separated farther from the resort 1 than the smart plate reader 5 is. Consequently, an approaching vehicle communicates with the smart plate reader 4 and the smart plate reader 5 in that order, while a receding vehicle communicates with the smart plate reader 5 and the smart plate reader 4 in that order.

FIG. 3 shows the position where the smart plate 9 is disposed in the number plate 10 attached to the front of the vehicle 8 in order to communicate with the smart plate readers 4 and 5. As illustrated, the smart plate 9 is embedded in the left upper part of the number plate 10.

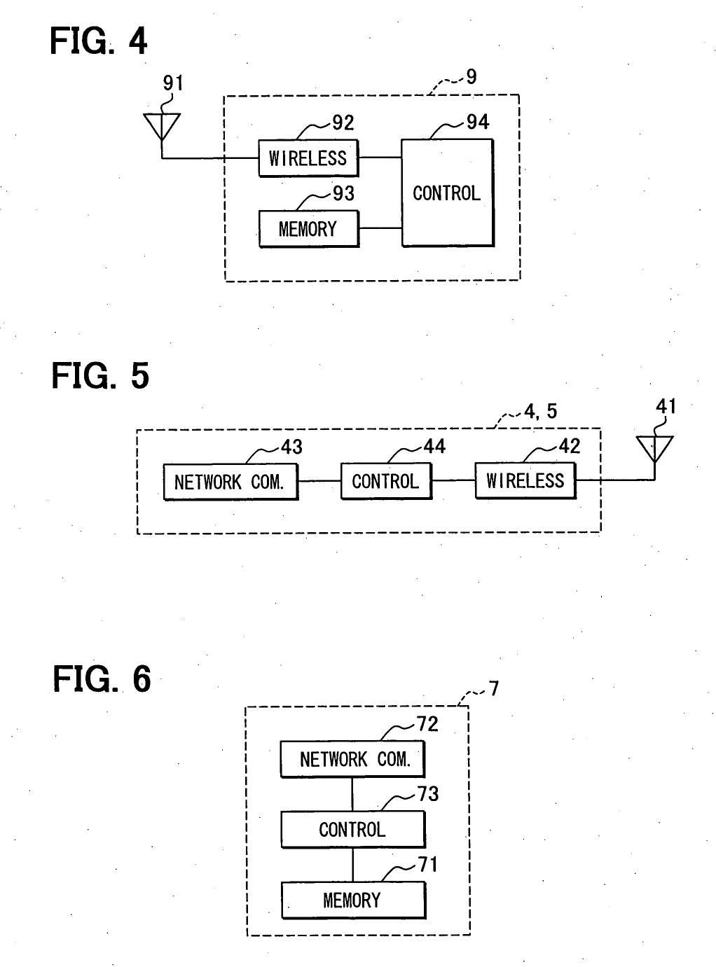

FIG. 4 shows the hardware configuration of the smart plate 9. The smart plate 9 comprises an antenna 91, a wireless unit 92, a memory 93, and a control unit 94.

The wireless unit 92 performs predetermined frequency conversion, demodulation, amplification, and analog-to-digital conversion on a signal received via the antenna 91, and transfers the resultant data to the control unit 94. Moreover, the wireless unit 92 performs predetermined digital-to-analog conversion, amplification, modulation, and frequency conversion on data received from the control unit 94, and transmits the resultant data via the antenna 91.

The memory 93 is a volatile memory or a nonvolatile memory. The memory 93 stores computer programs which the control unit 94 reads and runs and pieces of information on number plates of vehicles each having the smart plate 9.

The control unit 94 reads a program from the memory 93 and runs it; whereby, the control unit 94 starts up. Once the control unit 94 starts, the control unit 94 receives a signal sent from the smart plate reader 4 or 5 via the wireless unit 92, reads information on a number plate from the memory 93, and transmits by radio the read information on a number plate to the smart plate reader 4 or 5, which is an originator of the received signal, via the wireless unit 92.

When the smart plate 9 enters the communicative zone in which the smart plate readers 4 and 5 can communicate with the smart plate 9, the smart plate 9 receives signals from the smart plate readers 4 and 5 and then returns the information on the number plate 10 of the vehicle to which the number plate 10 is installed.

FIG. 5 shows the hardware configuration of the smart plate readers 4 and 5. The smart plate readers 4 and 5 share the same hardware configuration and each comprise an antenna 41, a wireless unit 42, a network communication unit 43, and a control unit 44.

The wireless unit 42 performs predetermined frequency conversion, demodulation, amplification, and analog-to-digital conversion on a signal received via the antenna 41, and transfers the resultant data to the control unit 44. Moreover, the wireless unit 42 performs predetermined digital-to-analog conversion, amplification, modulation, and frequency conversion on data received from the control unit 44, and transmits the resultant data via the antenna 41.

The network communication unit 43 manipulates data received from the control unit 44 in compliance with a communications protocol (for example, the TCP/IP) supported by the network 6, and transmits the resultant data to the server 7 over the network 6.

The control unit 44 receives information on a number plate sent from the smart plate 9 via the wireless unit 42, and transmits vehicle passage data, which specifies a current time instant, an identification (ID) number assigned to the smart plate reader 4 and 5 to which the control unit 44 is installed, and the received information on a number plate, to the server 7 via the network communication unit 43.

As mentioned above, the smart plate readers 4 and 5 transmit to the server 7 the vehicle passage data containing the received information on a number plate.

FIG. 6 shows the hardware configuration of the server 7. The server 7 comprises a memory 71, a network communication unit 72, and a control unit 73.

The memory 71 comprises (i) a hard disk in which programs to be run by the control unit 73 and data items received from the smart plate readers 4 and are stored, and (ii) a RAM to be used as a work area during run of a program. Moreover, the hard disk preserves pieces of information on number plates of multiple vehicles that is basically driven within the resort 1 such as vehicles being in the possession of an accommodation facility within the resort 1, that is, pieces of information on resort-based vehicles.

The network communication unit 72 receives vehicle passage data sent from the smart plate reader 4 or 5 over the network 6, converts the data into data that is formatted to be recognizable by the control unit 73, and transfers the resultant data to the control unit 73. The network communication unit 72 manipulates data received from the control unit 73 in compliance with a communications protocol supported by the network 6, and transmits the resultant data over the network 6.

The control unit 73 reads a program from the memory 71 and runs it; whereby, the control unit 73 starts up. Once the control unit 73 starts, the control unit 73 sorts vehicle passage data items, which are received from the smart plate readers 4 and 5, in ascending order of time instants specified in the respective passage data items, and stores the data items in the hard disk included in the memory 71.

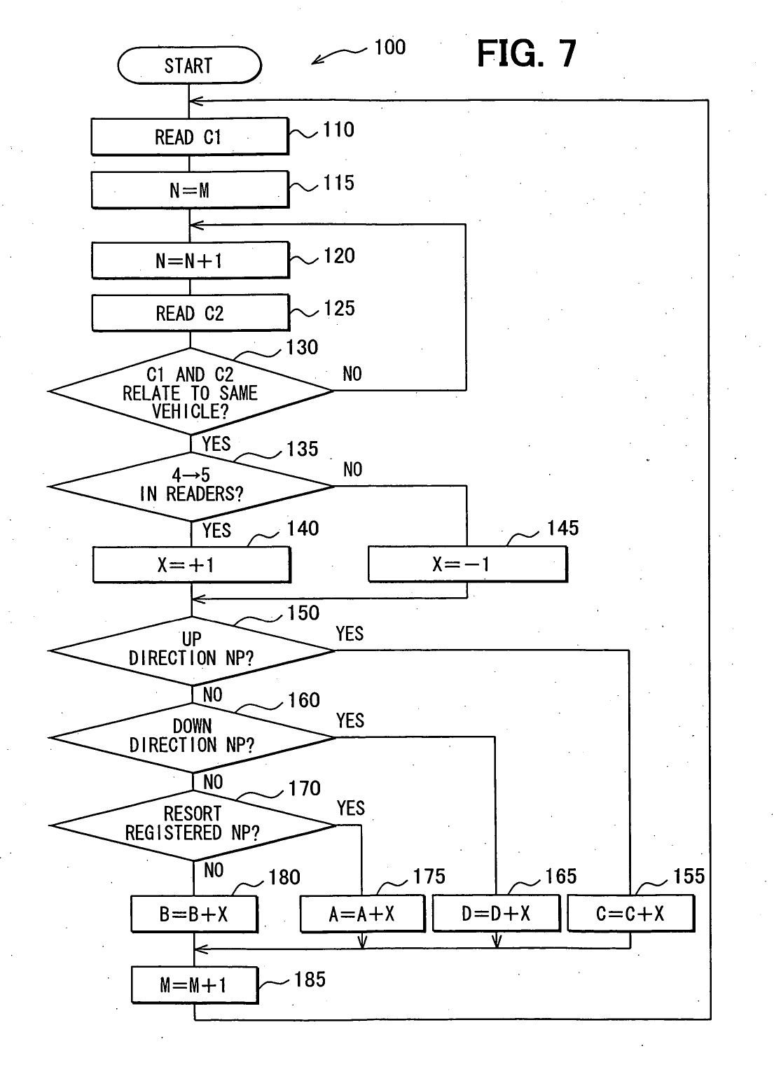

The control unit 73 counts (i) the number of local vehicles existing in the resort 1, (ii) the number of resort-based, vehicles, (iii) the number of vehicles driven in the up direction, and (iv) the number of vehicles driven in the down direction. These are counted on the basis of (i) the number of vehicles approaching the resort 1 and the number of vehicles receding from the resort 1, which are detected by the smart plate readers 4 and 5, and (ii) pieces of information on place names contained in the pieces of information on the number plates of the vehicles. Herein, information on a place name refers to data specifying a place name assigned to an area defined by the Land Transport Office or a motor vehicle official. This processing is implemented by running a number-of-vehicles count program 100 described in FIG. 7.

Moreover, the control unit 73 estimates the extents of traffic congestions on the general road 2 and expressway 3 at a subsequent time instant on the basis of the calculated numbers of local vehicles, resort-based vehicles, vehicles driven in the up direction, and vehicles driven in the down direction.

Now, the number-of-vehicles count program 100 will be described. Once the control unit 73 is activated, it repeatedly runs the number-of-vehicles count program 100. At Step 110, the control unit 73 reads from the memory 71 vehicle passage data identified with a variable M (natural number), or the M-th earliest vehicle passage data in time instants. The value of the variable M is incremented by one with every repetition of Step 110 to Step 185 included in the program. Immediately after the server 7 starts up, the M value may be set to 1 or a value to which the variable M is set immediately before the server 7 is inactivated. The data read at Step 110 is regarded as data C1.

At Step 115, the M value is assigned to a variable N.

At Step 120, the value of the variable N is incremented by one. At Step 125, the N-th vehicle passage data is read from the memory 71 and regarded as data C2.

At Step 130, information on a number plate contained in the data C1 is compared with information on a number plate contained in the data C2 in order to see whether the pieces of information are consistent with each other, that is, vehicles relevant to the data C1 and data C2 are identical to each other. When the pieces of information are consistent with each other, Step 135 is executed. Otherwise, Step 120 is executed.

As mentioned above, at Step 120 to Step 130, vehicle passage data of the same vehicle corresponding to the data C1 is retrieved from among vehicle passage data items that specify later time instants than the time instant specified in the data C1. The retrieved vehicle passage data is regarded as data C2.

At Step 135, number plate data items contained in the data C1 and data C2 are checked to see whether the smart plate readers 4 and 5 have received them in that order. Namely, identification data items representing ID numbers assigned to the smart plate readers and being contained in the data items C1 and C2 respectively are checked.

When the identification data representing the ID number of a smart plate reader and being contained in the data C1 indicates the smart plate reader 4, and the identification data representing the ID number of a smart plate reader and being contained in the data C2 indicates the smart plate reader 5, the smart plate readers 4 and 5 are recognized to have received the number plate data items in that order. Step 140 is then executed. In this case, one vehicle has been driven from the position of the smart plate reader 4 to the position of the smart plate reader 5, that is, has been driven on the general road 2 in a direction of approaching the resort 1.

When the identification data representing the ID number of a smart plate reader and being contained in the data C1 indicates the smart plate reader 5 and the identification data representing the ID number of a smart plate reader and being contained in the data C2 indicates the smart plate reader 4, the smart plate readers 5 and 4 are recognized to have received the number plate data items in that order. Step 145 is then executed. In this case, one vehicle has been driven from the position of the smart plate reader 5 to the position of the smart plate reader 4, that is, has been driven on the general road 2 in a direction of receding from the resort 1.

At Step 140, a value +1 is assigned to the variable X. At Step 145, a value −1 is assigned to the variable X.

At Step 150 following Step 140 or Step 145, the pieces of information on number plates contained in the data items C1 and C2 respectively are checked to see whether they contain pieces of information on place names that are found in an up direction of the expressway 3. The up direction of the expressway 3 corresponds to the direction in the up lane of the expressway 3 shown in FIG. 1. When the pieces of information represent a place name of a place where a vehicle reaches after descending a ramp at a junction located in the up direction away from the junction at which the general road 2 meets the expressway 3, the pieces of information on number plates are associated with the up direction of the expressway 3. Incidentally, correspondence data that is information on the correspondence of place names with the up direction or down direction in which the place names are found is stored in the hard disk included in the memory 71. When a number plate is associated with the up direction of the expressway 3, Step 155 is executed. Otherwise, Step 160 is executed.

At Step 155, a variable C is updated by adding the value of the variable X determined at Step 140 or Step 145 to the variable C.

At Step 160, pieces of information on number plates contained in the data items C1 and C2 respectively are checked to see whether they contain information on a place name that is found in the down direction of the expressway 3. The down direction of the expressway 3 corresponds to the direction in which the down lane of the expressway 3 shown in FIG. 1. When the pieces of information contain information on a place name that is found after a vehicle descends a ramp at a junction located in the down direction away from the junction at which the general road 2 meets the expressway 3, the pieces of information on number plates are associated with the down direction of the expressway 3. When the number plates are associated with the down direction of the expressway 3, Step 165 is executed. Otherwise, Step 170 is executed.

At Step 165, a variable D is updated by adding the value of the variable X determined at Step 140 or Step 145 to the variable D.

At Step 170, the pieces of information on number plates contained in the data items C1 and C2 are checked to see whether they are pieces of information on a number plate of a vehicle registered in the resort. Namely, the pieces of information on number plates are checked to see whether a vehicle identified with the data items C1 and C2 is a vehicle registered in the resort. When the vehicle is a vehicle registered in the resort, Step 170 is executed. Otherwise, Step 180 is executed.

At Step 175, a variable A is updated by adding the value of the variable X determined at Step 140 or Step 145 to the variable A.

At Step 180, a variable B is updated by adding the value of the variable X determined at Step 140 or Step 145 to the variable B.

At Step 185 following Step 155, Step 165, Step 175, or Step 180, the value of the variable M is incremented by one. Step 110 is executed subsequently to Step 185.

By running the number-of-vehicles count program 100, the control unit 73 verifies whether vehicles driven through the general road 2 are approaching the resort 1 or receding from the resort 1 (refer to Step 135). Moreover, the control unit 73 verifies whether information on a place name contained in information on a number plate of a vehicle represents a place name found in the up direction of the expressway 3 (refer to Step 150) or represents a place name found in the down direction of the expressway 3 (refer to Step 140). When the number plate indicates neither the place name found in the up direction nor the place name found in the down direction, the control unit 73 verifies whether the vehicle is a vehicle registered in the resort (Step 170). When the number plate indicates neither the place name found in the up direction nor the place name found in the down direction, the vehicle is recognized as a local vehicle that is basically driven in the resort 1 and an area near the resort 1.

Based on the results of the verifications,

(1) assuming that the vehicle is a vehicle registered in the resort,

(1-1) when the vehicle is approaching the resort, the control unit 73 increments the variable A by one, or

(1-2) when the vehicle is receding from the resort, the control unit 73 decrements the variable A by one.

(2) Assuming that the vehicle is a local vehicle other than the vehicle registered in the resort,

(2-1) when the vehicle is approaching the resort, the control unit 73 increments the variable B by one, or

(2-2) when the vehicle is receding from the resort, the control unit 73 decrements the variable B by one.

(3) Assuming that the vehicle is a vehicle driven in the up direction of the expressway 3,

(3-1) when the vehicle is approaching the resort, the control unit 73 increments the variable C by one, or

(3-2) when the vehicle is receding from the resort, the control unit 73 decrements the variable C by one.

(4) Assuming that the vehicle is a vehicle driven in the down direction of the expressway 3,

(4-1) when the vehicle is approaching the resort, the control unit 73 increments the variable D by one, or

(4-2) when the vehicle is receding from the resort, the control unit 73 decrements the variable D by one.

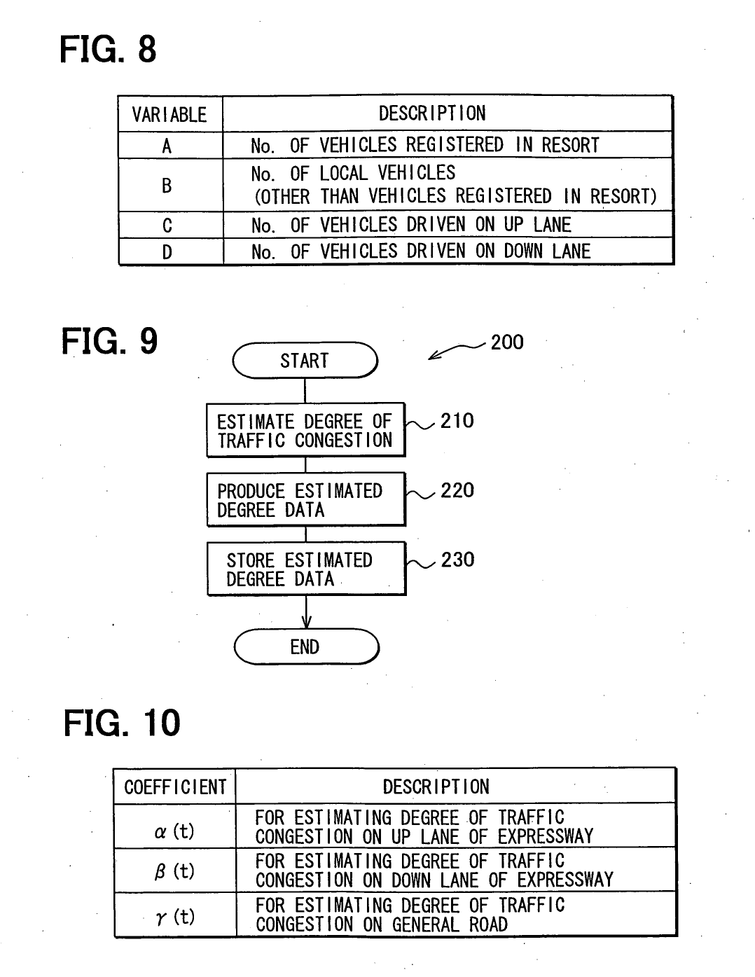

Consequently, as listed in the table of FIG. 8, the variable A signifies the number of resort-based vehicles currently existing in the resort 1. The variable B signifies the number of local vehicles other than the resort-based vehicles currently existing in the resort 1. The variable C signifies the number of vehicles currently existing in the resort 1 after being driven from the up direction of the expressway 3. The variable D signifies the number of vehicles currently existing in the resort 1 after being driven from the down direction of the expressway 3.

Degree-of-traffic congestion estimation to be implemented by the control unit 73 will be described below. In order to implement the degree-of-traffic congestion estimation, the control unit 73 repeatedly runs a degree-of-traffic congestion estimation program 200 described in FIG. 9. First, at Step 210, a degree of traffic congestion is estimated.

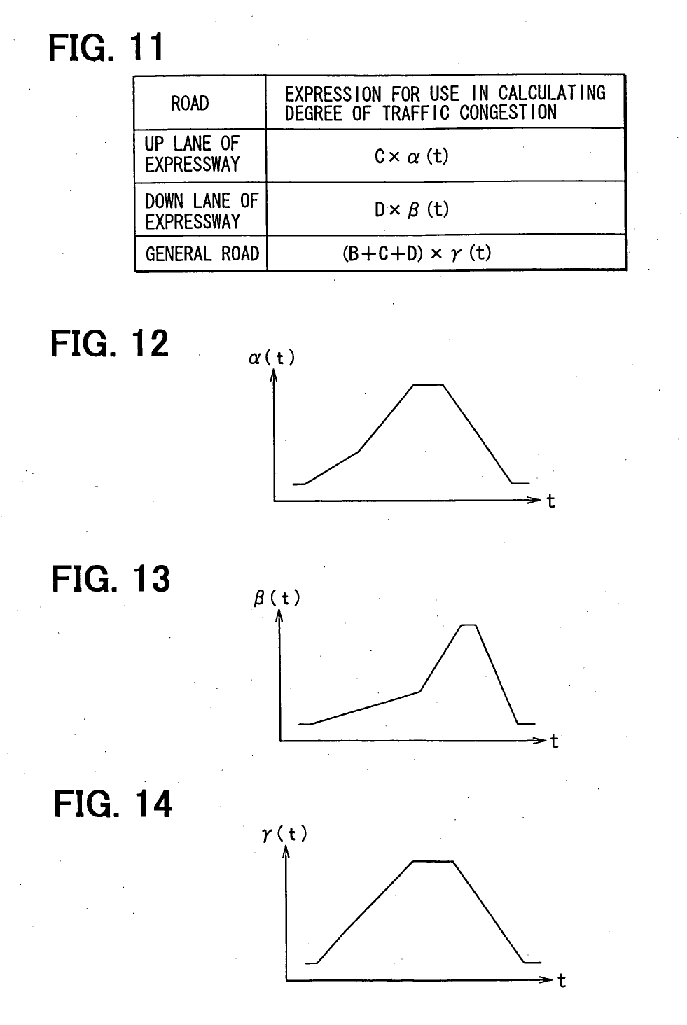

FIG. 10 and FIG. 11 show tables to be referenced in order to explain the degree-of-traffic congestion estimation method. For estimation of a degree of traffic congestion, three degree-of-traffic congestion coefficients α(t), β(t), and γ(t) that are functions of a time instant t (ranging from 00:00 to 23:59) are employed. The graphs of functions expressing the coefficients are stored in advance in the hard disk included in the memory 71. The coefficients α(t), β(t), and γ(t) have the same dimension of (the degrees of traffic congestions/the numbers of vehicles) with respect to each of the up lane of the expressway 3, the down lane of the expressway 3, and the general road 2. The degree of traffic congestion may be expressed with an expected distance by which a traffic jam extends on a specific road or may be expressed with an expected mean number of vehicles per unit distance on a specific road.

FIG. 12, FIG. 13, and FIG. 14 are graphs showing examples of the graphs of functions expressing the coefficients α(t), β(t), and γ(t), respectively. The axis of abscissas indicates time instants t (00:00≦t≦23:59), and the axis of ordinates indicates coefficient values. The values of the coefficients α(t), β(t), and γ(t) respectively is smaller than 1. In FIG. 12 to FIG. 14, the graphs of functions have their peaks at points beyond the centers of the axes of abscissas (indicating the noon), that is, at points indicating time instants in the evening, and indicate small values in association with midnight time instants. The graphs of functions are plotted on the assumption that a flow rate of vehicles gets higher in the evening and is almost zero in the midnight. The values of the coefficients α(t), β(t), and γ(t) may be determined based on pieces of statistical information on the degrees of traffic congestions on the respective roads that are detected previously. The functions of the coefficients α(t), β(t), and γ(t) may be varied depending on a day of the week when the degrees of traffic congestions are estimated. Otherwise, the functions may be varied depending on whether the date when the degrees of traffic congestions are estimated is a holiday, one of the first ten days of a month, one of the last ten days of a month, a day in the beginning of a year, a day in the end of a year, or the like.

An expression for use in calculating a degree of traffic congestion is, as shown in the table of FIG. 11, different from road to road. Specifically, a degree of traffic congestion at a time instant t (within 24 hours from now on) on the up lane of the expressway 3 is a product of the variable C by the coefficient α(t). A degree of traffic congestion at the time instant t (within 24 hours from now on) on the down lane of the express way 3 is a product of the variable D by the coefficient β(t). A degree of traffic congestion at the time instant t (within 24 hours from now on) on the general road 2 is a product of the sum of the variables B, C, and D by the coefficient γ(t).

As mentioned above, among the number of vehicles calculated within the number-of-vehicles count program 100, only the number of strange vehicles driven from the up direction C contributes to the prospective degree of traffic congestion on the up lane of the expressway 3, but the number of strange vehicles driven from the down direction D and the number of local vehicles (A+B) do not contribute thereto. Moreover, only the number of strange vehicles driven from the down lane D contributes to the prospective degree of traffic congestion on the down lane of the expressway 3, but the number of strange vehicles driven in the up direction C and the number of local vehicles (A+B) do not contribute thereto. Moreover, the number of local vehicles other than resort-based vehicles B, the number of strange vehicles driven from the up direction C, and the number of strange vehicles driven from the down direction D contribute to the prospective degree of traffic congestion on the general road 2, but the number of resort-based vehicles A does not contribute thereto.

At Step 220, data of an estimated degree-of-traffic congestion is produced based on the degree of traffic congestion on each road calculated at Step 210. The estimated degree-of-traffic congestion data may be text data representing a calculated degree of traffic congestion or data representing a display image 30, which expresses an estimated extent of traffic congestion, like the one shown in FIG. 15. The display image 30 expressing an estimated extent of traffic congestion is a bisected screen image and comprises a left-hand map display image 31 and a right-hand graph display image 32. The map display image 31 is an image having a highlight 33, which expresses a traffic jam identified based on a degree of traffic congestion equal to or larger than a reference value, superimposed on a schematic map that shows the resort 1, general road 2, and expressway 3 that are objects of degree-of-traffic congestion estimation. The graph display image 32 is a graph whose axis of abscissas indicates time instants and whose axis of ordinates indicates distances by which the traffic jam expressed by the highlight 33 extends.

At Step 230, the thus produced estimated degree-of-traffic congestion data is stored in the hard disk included in the memory 71. After completion of Step 230, one run of the degree-of-traffic congestion estimation program 200 is completed. The stored estimated degree-of-traffic congestion data may be transmitted to any other traffic information acquisition equipment accommodated in the network 6 via the network communication unit 72. Otherwise, the server 7 may use the stored estimated degree-of-traffic congestion data to perform various pieces of statistical processing later.

Owing to the foregoing actions of the control unit 73, the road traffic congestion degree estimation system uses the smart plate readers 4 and 5 to acquire pieces of information on number plates 10 of vehicles 8 that are driven on the general road 2 in a direction of approaching the resort 1 and vehicles that are driven on the general road 2 in a direction of receding from the resort 1. Based on the detected numbers of approaching vehicles 8 and of receding vehicles 8, and pieces of information on place names contained in the pieces of information on number plates 10, the server 7 calculates the number of strange vehicles existing in the resort 1 after driven from the up direction, the number of strange vehicles existing in the resort 1 after driven from the down direction, the number of resort-based vehicles, the number of local vehicles other than the resort-based vehicles. The server 7 then estimates the prospective extents of traffic congestions on the expressway 3 and the general road 2 alike on the basis of the calculated numbers of strange vehicles and the calculated number of local vehicles. As for the expressway 3, the prospective extent of traffic congestion is estimated on the assumption that the number of strange vehicles will contribute more greatly to an increase in the degree of traffic congestion than the number of local vehicles will. Moreover, as for the general road 2, the prospective extent of traffic congestion is estimated on the assumption that the number of other vehicles will contribute more greatly to an increase in the degree of congestion than the number of resort-based vehicles will.

Consequently, based on the numbers of local vehicles and strange vehicles existing in a certain area, the road traffic congestion degree estimation system estimates a degree of traffic congestion on a road that extends from the certain area to the outside of the certain area and that allows vehicles to travel from the certain area to an area where the local vehicles are originally driven.

### SECOND EMBODIMENT

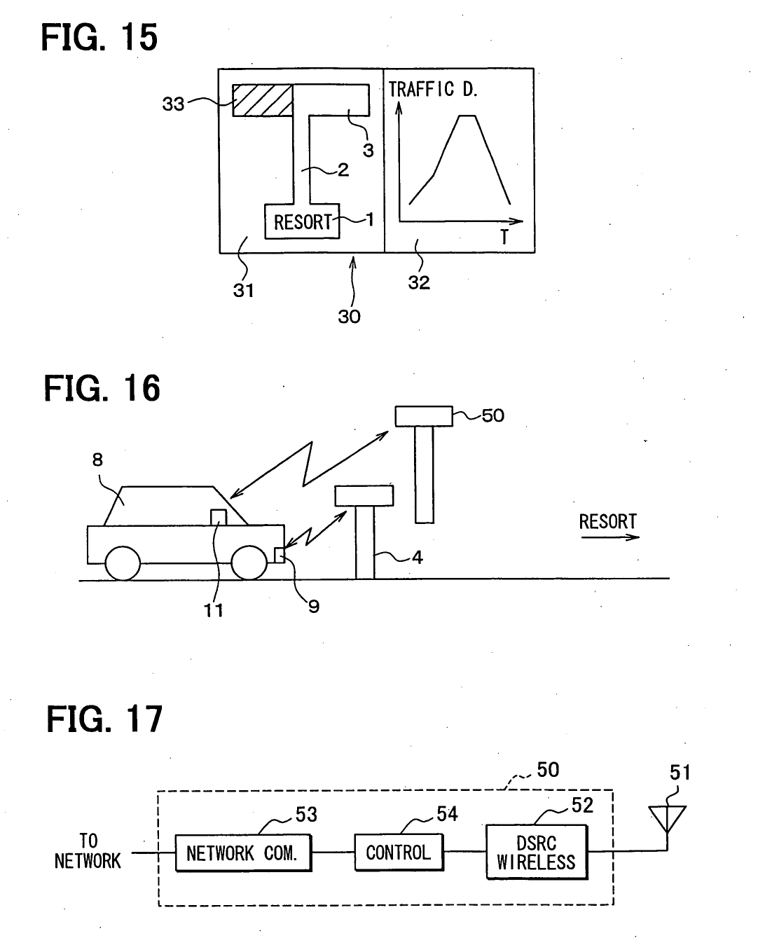

Next, the second embodiment of the present invention will be described below. FIG. 16 is a side view of part of a general road 2 employed in the present embodiment. A difference of the present embodiment from the first embodiment is that a road traffic congestion degree estimation system in accordance with the present embodiment includes a dedicated short range communications (DSRC) on-road machine 50 in place of the smart plate reader 5. The DSRC on-road machine 50 acquires information on a scheduled drive route along which a vehicle is driven, or information on a direction of advancement, in which the vehicle advances, from a car navigation system 11 mounted in the vehicle. Hereinafter, the information on a scheduled drive route and the information on a direction of advancement are generically referred to as navigational information. The distance between the smart plate reader 4 and the DSRC on-road machine 50 is very short (for example, 10 m or less).

The difference of the present embodiment from the first embodiment will be described below. The car navigation system 11 from which the DSRC on-road machine 50 acquires information on a scheduled drive route or information on a direction of advancement has the ability to calculate an optimal route to a designated destination and display a guide image showing the optimal route as a scheduled drive route, and has the ability to transmit information on the scheduled drive route or a direction of advancement to the DSRC on-road machine 50 through radio-communication conformable to the DSRC standards.

FIG. 17 shows the hardware configuration of the DSRC on-road machine 50. The DSRC on-road machine 50 comprises an antenna 51, a DSRC wireless unit 52, a network communication unit 53, and a control unit 54.

The DSRC wireless unit 52 performs frequency conversion, demodulation, amplification, and analog-to-digital conversion on a signal, which is received from the car navigation system 11 via the antenna 51, according to the DSRC standards, and transfers the resultant data to the control unit 54. Moreover, the DSRC wireless unit 52 performs digital-to-analog conversion, amplification, modulation, and frequency conversion on data received from the control unit 54 according to the DSRC standards, and transmits the resultant data via the antenna 51.

The network communication unit 53 manipulates data received from the control unit 54 in compliance with a communications protocol supported by a network 6, and transmits the resultant data to a server 7 over the network 6.

The control unit 54 receives navigational information sent from the car navigation system 11 via the DSRC wireless unit 52, and transmits a set of a current time instant, an identification (ID) number assigned to the DSRC on-road machine to which the control unit 54 is installed, and the received navigational information to the server 7 via the network communication unit 53.

As mentioned above, the DSRC on-road machine 50 transmits the received navigational information and the own ID number to the server 7.

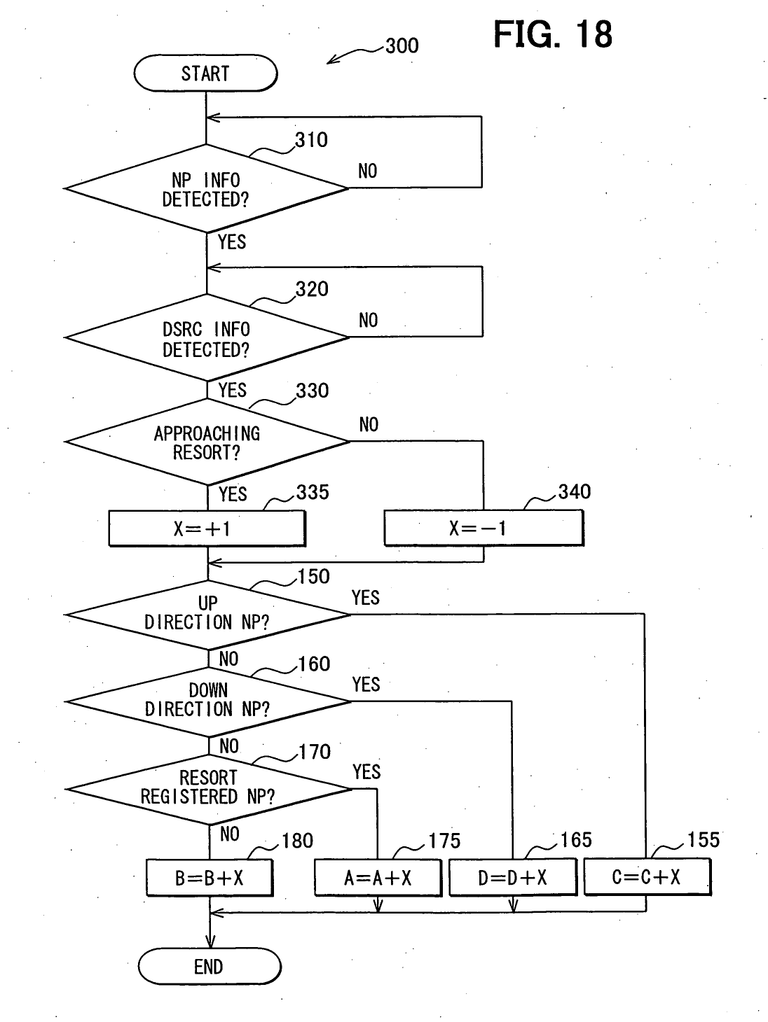

FIG. 18 describes a number-of-vehicles count program 300 which a control unit 73 included in the server 7 employed in the present embodiment repeatedly runs in place of the number-of-vehicles count program 100. Along with the run of the number-of-vehicles count program 300, the control unit 73 waits at Step 310 until it newly receives information on a number plate from the smart plate reader 4. On receipt of the information, the control unit 73 waits at Step 320 until it receives navigational information, which is sent from the car navigation system 11 mounted in a vehicle identified with the information on a number plate, from the DSRC on-road machine 50. On receipt of the navigational information, the control unit executes Step 330.

Whether navigational information and information on a number plate are concerned with the same vehicle may be verified based on whether a difference between a time instant when the server 7 receives the navigational information and a time instant when the server 7 receives the information on a number plate is shorter than a reference time. When the car navigation system 11 transmits information on the number plate of the vehicle to which the car navigation system is installed together with the navigational information, the DSRC on-road machine 50 may transfer the navigational information containing the information on the number plate to the server 7. The server 7 may collate the information on the number plate contained in the navigational information with information on a number plate sent from the smart plate reader 4, and may thus verify whether the navigational information and the information on a number plate sent from the smart plate reader 4 are concerned with the same vehicle.

At Step 330, the navigational information is checked to see whether the vehicle is approaching the resort 1 or receding from the resort 1. Assuming that the navigational information is information on a scheduled drive route, when the destination of the route is the resort 1, the vehicle is recognized to be approaching the resort 1. When the destination is not the resort 1, the vehicle is recognized to be receding from the resort 1.

When the vehicle is recognized to be approaching the resort 1, the variable X is set to 1 at Step 335. When the vehicle is recognized to be receding from the resort 1, the variable X is set to −1 at Step 340. Step 150 is executed subsequently to Step 335 or Step 340.

The processing from Step 150 to Step 180 is equivalent to the one from Step 150 to Step 180 included in the number-of-vehicles count program 100. After Step 155, Step 165, Step 175, or Step 185 is completed, one run of the number-of-vehicles count program 300 is completed.

Every time the control unit 73 receives information on a number plate from the smart plate reader 4, the control unit 73 can rerun the number-of-vehicles count program 300 from Step 320. Thus, multiple runs of the number-of-vehicles count program 300 can proceed concurrently. However, in this case, the variables A, B, C, and D are shared among the multiple concurrent runs of the number-of-vehicles count program 300.

As mentioned above, a direction in which a vehicle is driven may be determined based on navigational information received from the DSRC on-road machine 50. Nevertheless, the same advantages as those of the first embodiment can be provided.

### THIRD EMBODIMENT

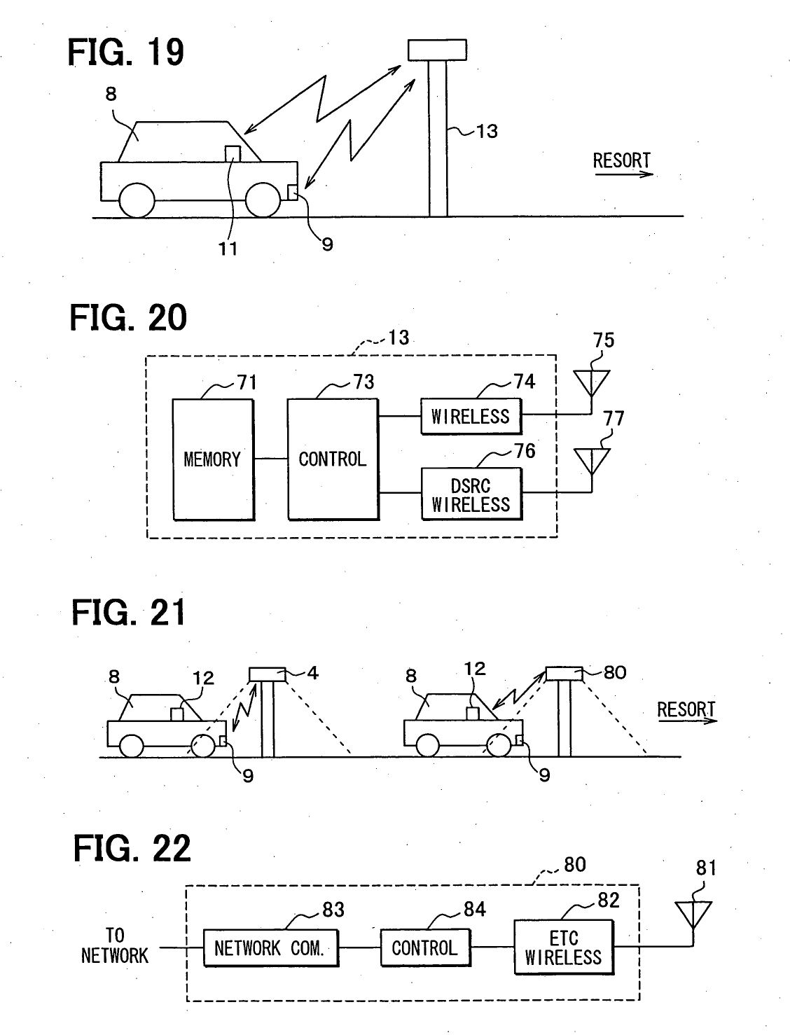

Next, the third embodiment of the present invention will be described below. FIG. 19 is a side view of part of a general road 2 employed in the present embodiment. A difference of the present embodiment from the second embodiment is that a road traffic congestion degree estimation system in accordance with the present embodiment includes a composite on-road machine 13 having the capabilities of the server 7, smart plate reader 4, and DSRC on-road machine 50 in place of the server 7, smart plate reader 4, and DSRC on-road machine 50 (equivalent to a road traffic congestion degree estimation system and a road traffic congestion degree estimation apparatus).

FIG. 20 shows the hardware configuration of the composite on-road machine 13. The composite on-road machine 13 comprises a memory 71, a control unit 73, a wireless unit 74, an antenna 75, a DSRC wireless unit 76, and an antenna 77.

The memory 71 and control unit 73 are the same hardware devices as the components 71 and 73 of the server 7.

The wireless unit 74 performs predetermined frequency conversion, demodulation, amplification, and analog-to-digital conversion on a signal received from the smart plate 9 via the antenna 75, and transfers the resultant data to the control unit 73. Moreover, the wireless unit 74 performs predetermined digital-to-analog conversion, amplification, modulation, and frequency conversion on data received from the control unit 73, and transmits the resultant data via the antenna 75.

The DSRC wireless unit 76 performs frequency conversion, demodulation, amplification, and analog-to-digital conversion on a signal received from the car navigation system 11 via the antenna 77 according to the DSRC standards, and transfers the resultant data to the control unit 73. Moreover, the DSRC wireless unit 76 performs digital-to-analog conversion, amplification, modulation, and frequency conversion on data received from the control unit 73 according to the DSRC standards, and transmits the resultant data via the antenna 51.

Similarly to the control unit 54 included in the DSRC on-road machine 50 employed in the second embodiment, the control unit 73 runs a number-of-vehicles count program 300 and a degree-of-traffic congestion estimation program 200 according to information on a number plate received from the wireless unit 74 and navigational information received from the DSRC wireless unit 76.

Owing to the foregoing actions, the same advantages as those of the second embodiment are provided by employment of the one composite on-road machine 13.

### FOURTH EMBODIMENT

Next, the fourth embodiment of the present invention will be described below. FIG. 21 is a side view of part of a general road 2 employed in the present embodiment. A difference of the present embodiment from the first embodiment is that a road traffic congestion degree estimation system in accordance with the present embodiment includes an on-road machine 80 that is a component of an electronic toll collection (ETC) system in place of the smart plate reader 5. The road traffic congestion degree estimation system in accordance with the present embodiment checks the order, in which a vehicle accesses the smart plate reader 4 and the ETC on-road machine 80, to see whether the vehicle is approaching the resort 1 or receding from the resort 1. The difference of the present embodiment from the first embodiment will be described below.

FIG. 22 shows the hardware configuration of the ETC on-road machine 80. The ETC on-road machine 80 comprises an antenna 81, an ETC wireless unit 82, a network communication unit 83, and a control unit 84.

The ETC wireless unit 82 performs frequency conversion, demodulation, amplification, and analog-to-digital conversion on a signal, which is received from an ETC on-board device 12 mounted in a vehicle 8 via the antenna 81, according to the ETC standards, and transfers the resultant data to the control unit 84. Moreover, the ETC wireless unit 82 performs digital-to-analog conversion, amplification, modulation, and frequency conversion on data received from the control unit 84 according to the ETC standards, and transmits the resultant data via the antenna 81.

The network communication unit 83 manipulates or processes data received from the control unit 84 in compliance with a communications protocol supported by a network 6, and transmits the resultant data to a server 7 over the network 6.

The control unit 84 receives data of a vehicle number from the ETC on-board device 12 via the ETC wireless unit 82, and transmits information on a vehicle, which contains a current time instant, an identification (ID) number assigned to the ETC on-road machine 80 to which the control unit 84 is installed, and the received vehicle number data, to the server 7 via the network communication unit 83.

As mentioned above, the ETC on-road machine 80 transmits vehicle passage data, which contains the received vehicle number data, to the server 7.

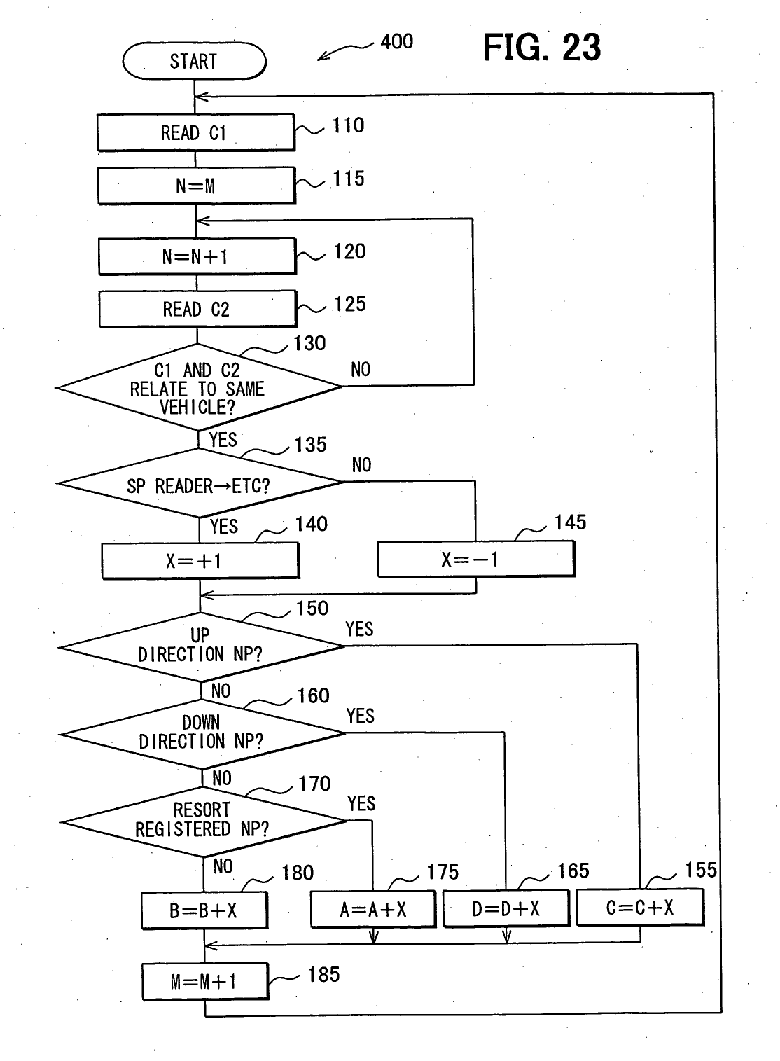

FIG. 23 is a flowchart describing a number-of-vehicles count program 400 which the control unit 73 included in the present embodiment runs in place of the number-of-vehicles count program 100. Steps included in the number-of-vehicles count program 400 and assigned the same step numbers as those included in the number-of-vehicles count program 100 described in FIG. 7 have the same contents as the counterparts included in the number-of-vehicles count program 100. However, the number-of-vehicles count program 400 reads the ETC on-road machine 80 in place of the smart plate reader 5 described in the number-of-vehicles count program 100.

As mentioned above, even when the ETC on-road machine 80 is substituted for the smart plate reader 5, the same advantages as those of the first embodiment can be provided.

### FIFTH EMBODIMENT

Next, the fifth embodiment of the present invention will be described. A difference of the present embodiment from the first embodiment is that a road traffic congestion degree estimation system in accordance with the present embodiment detects the number of vehicles parked in an accommodation facility within a resort 1, and reflects the number of vehicles in prospective degrees of traffic congestions on a general road 2 and an expressway 3. This is based on the idea that since a vehicle in an accommodation facility often stays overnight in the accommodation facility, there is a high possibility that the time instant when the vehicle leaves the resort 1 is one day or more later than the time instants when the other vehicles in the resort 1 leave the resort.

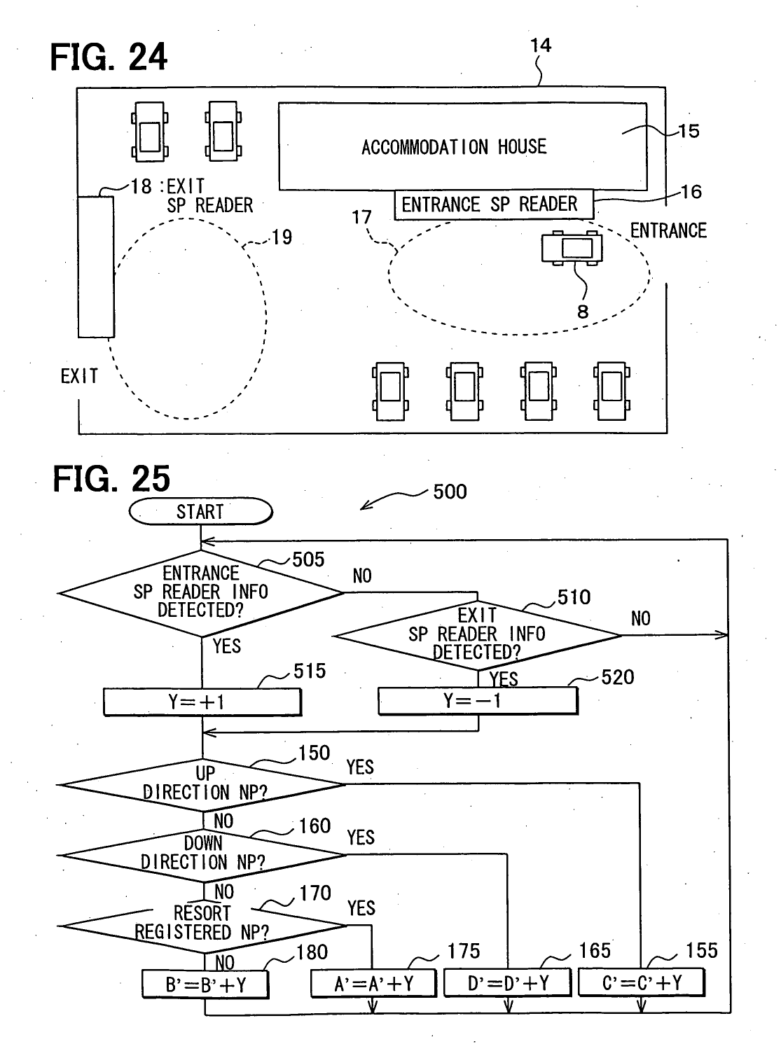

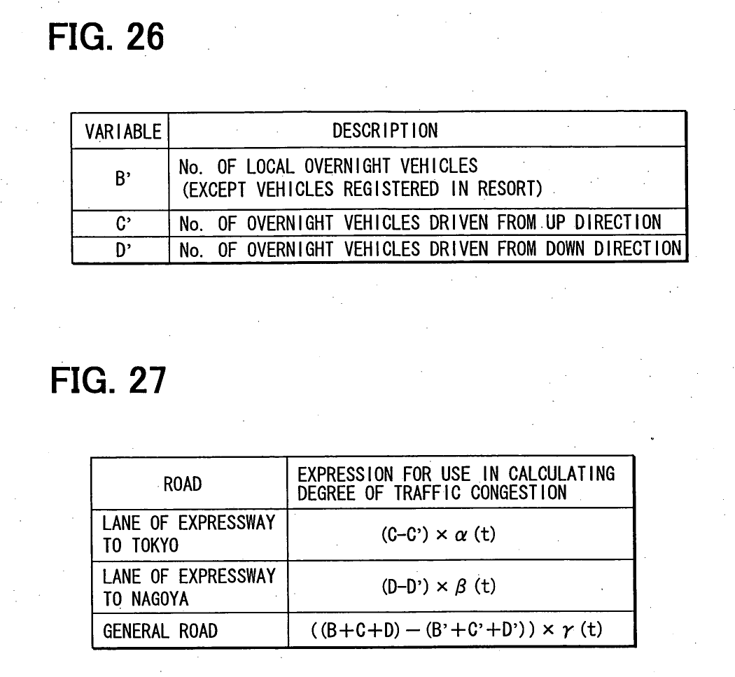

According to the present embodiment, a device for detecting vehicles is installed in the premises of an accommodation facility as part of a road traffic congestion degree estimation system. FIG. 24 is a bird's-eye view of an accommodation facility 14 having the device installed in the premises thereof. An entrance smart plate reader 16 is attached to the outer wall of an accommodation house 15 in the vicinity of the entrance of the accommodation facility 14. A communication enabled zone 17 is defined to be a zone within which the entrance smart plate reader 16 can communicate with a smart plate. The communication enabled zone 17 covers a range through which a vehicle 8 is driven without fail when visiting the accommodation facility 14 through the entrance thereof. Moreover, an exit smart plate reader 18 is disposed on a wall near the exit of the accommodation facility 14. A communication enabled zone 19 is defined to be a zone within which the exit smart plate reader 18 can communicate with a smart plate. The communication enabled zone 19 covers a range through which the vehicle is driven almost without fail when leaving the accommodation facility 14 through the exit thereof.

The hardware configuration of the entrance smart plate reader 16 and the exit smart plate reader 18 is comparable to that of the smart plate readers 4 and 5. The entrance smart plate reader 16 and exit smart plate reader 18 transmit, similarly to the smart plate readers 4 and 5, information on a vehicle, which has entered the communicative zones 17 and 19, to a server 7 over a network 6.

Moreover, a control unit 73 included in the server 7 employed in the present embodiment performs the same actions as the one employed in the first embodiment. Moreover, the control unit 73 runs a number-of-overnight vehicles count program 500 described in FIG. 25. At Step 505 and Step 510, the control unit 73 waits for information on a vehicle sent from the entrance smart plate reader 16 or the exit smart plate reader 18. On receipt of the information on a vehicle from the entrance smart plate reader 16, the value of a variable Y is set to 1 at Step 515. On receipt of the information on a vehicle from the exit smart plate reader 18, the value of the variable Y is set to −1 at Step 520.

Step 150 is executed subsequently to Step 515 or Step 520. The processing from Step 150 to Step 180 is identical to the processing of Step 150 to Step 180 included in the number-of-vehicles count program 100 described in FIG. 7. However, at Step 155, Step 165, Step 175, and Step 180, the value of the variable Y is added to variables C′, D′, A′, and B′, respectively. Step 505 is executed subsequently to Step 155, Step 165, Step 175, or Step 185.

By running the number-of-overnight vehicles count program 500, the control unit 73 acquires information on a vehicle that visits or leaves the accommodation facility 14.

(1) Assuming that the vehicle is a vehicle registered in the resort,

(1-1) when the vehicle visits the accommodation facility 14, the variable A′ is incremented by one, or

(1-2) when the vehicle leaves the accommodation facility 14, the variable A′ is decremented by one.

(2) Assuming that the vehicle is a local vehicle other than the vehicle registered in the resort,

(2-1) when the vehicle visits the accommodation facility 14, the variable B′ is incremented by one, or

(2-2) when the vehicle leaves the accommodation facility 14, the variable B′ is decremented by one.

(3) Assuming that the vehicle is a vehicle driven from the up direction,

(3-1) when the vehicle visits the accommodation facility 14, the variable C′ is incremented by one, or

(3-2) when the vehicle leaves the accommodation facility 14, the variable C′ is decremented by one.

(4) Assuming that the vehicle is a vehicle driven from the down direction,

(4-1) when the vehicle visits the accommodation facility 14, the variable D′ is incremented by one, or

(4-2) when the vehicle leaves the accommodation facility 14, the variable D′ is decremented by one.

Consequently, the variable A′ signifies the number of resort-based vehicles currently existing in the accommodation facility 14. The variable B′ signifies the number of local vehicles other than the resort-based vehicles currently existing in the accommodation facility 14. The variable C′ signifies the number of vehicles currently existing in the accommodation facility 14 after being driven from the up direction. The variable D′ signifies the number of vehicles currently existing in the accommodation facility 14 after being driven from the down direction (see the table of FIG. 16).

Incidentally, when the entrance smart plate reader and the exit smart plate reader are installed in multiple accommodation facilities within the resort 1, the control unit 73 runs the number-of-overnight vehicles count program 500 according to pieces of information on vehicles sent from all the entrance smart plate readers and exit smart plate readers. Consequently, the variables A′, B′, C′, and D′ each signify a sum total of specific vehicles existing in all the accommodation facilities.

The control unit 73 employed in the present embodiment adopts as an expression, which is used to calculate a degree of traffic congestion during degree-of-traffic congestion estimation to be executed as Step 210 in the degree-of-traffic congestion estimation program 200 described in FIG. 9, the following expression. Namely, the expression lowers the contribution of the accommodation facility 14 to the degree of traffic congestion by, as shown in the table of FIG. 27, subtracting the number of vehicles existing in the accommodation facility 14 from the number of vehicles existing in the resort 1. Specifically, a degree of traffic congestion at a time instant t (within 24 hours from now on) on the up lane of an expressway 3 is provided as a product of a difference between the variables C and C′ by a coefficient α(t). Moreover, a degree of traffic congestion at the time instant t (within 24 hours from now on) on the down lane of the expressway 3 is provided as a product of a difference between the variables D and D′ by a coefficient β(t). Moreover, a degree of traffic congestion at the time instant t (within 24 hours from now on) on the general road 2 is provided as a product of a value, which is calculated by subtracting the sum total of the variables B′, C′, and D′ from the sum total of the variables B, C, and D, by a coefficient γ(t).

When vehicles existing in all accommodation facilities within the resort 1 cannot be detected, a product of the number of vehicles existing in an accommodation facility by a coefficient larger than 1 is subtracted from the number of vehicles existing in the resort 1 in order to lower the contribution of the accommodation facility 14 to a degree of traffic congestion.

Consequently, the road traffic congestion degree estimation system in accordance with the present embodiment not only provides the same advantages as those of the first embodiment but also can more finely estimate a degree of traffic congestion in consideration of stay of vehicles in the resort 1.

### SIXTH EMBODIMENT

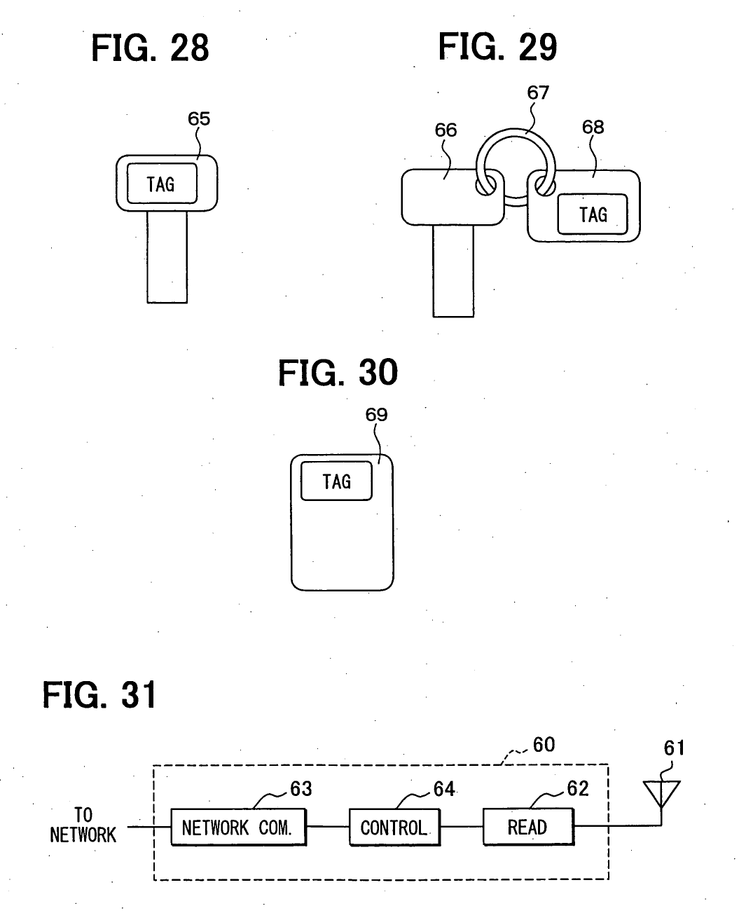

Next, the sixth embodiment of the present invention will be described below. A difference of the present embodiment from the fifth embodiment is that multiple tag readers are included in a road traffic congestion degree estimation system and installed in respective accommodation facilities; the multiple tag readers read pieces of information on number plates from respective handheld tag devices and transmit the read pieces of information to a server 7. Thus, the number of vehicles in the accommodation facilities within a resort 1 is calculated. What is referred to as a handheld tag device is a compact radio transmitter comprising a storage medium in which information on a number plate of a vehicle is stored and a wireless unit that transmits the information by radio, such as, an IC tag. The handheld tag device may be, as shown in FIG. 28, embedded in a tag-incorporated key 65 of a vehicle, may be, as shown in FIG. 29, embedded in a key holder 68 linked to a key 66 of a vehicle by a key ring 67, or may be embedded in a smart key 69 of a vehicle.

FIG. 31 shows the hardware configuration of a tag reader 60 that communicates with the handheld tag device so as to acquire information on a number plate. The tag reader 60 comprises an antenna 61, a read unit 62, a network communication unit 63, and a control unit 64.

The read unit 62 performs predetermined frequency conversion, demodulation, amplification, and analog-to-digital conversion on a signal that carries information on a number plate and that is received from the handheld tag device via the antenna 61, and transfers the resultant data to the control unit 64. Moreover, the read unit 62 performs predetermined digital-to-analog conversion, amplification, modulation, and frequency conversion on data received from the control unit 64, and transmits the resultant data via the antenna 61.

The network communication unit 63 manipulates data received from the control unit 64 in compliance with a communications protocol supported by a network 6, and transmits the resultant data to a server 7 over the network 6.

The control unit 64 transmits a signal, which carries a request for transmission of information from the handheld tag device, via the read unit 62. When the control unit 64 receives information on a number plate, which the handheld tag device has transmitted in response to the request, via the read unit 62, the control unit 64 transmits overnight vehicle data, which specifies a current time instant, an identification (ID) number assigned to the tag reader to which the control unit 64 is installed, and the received information on a number plate, to the server 7 via the network communication unit 63.

As mentioned above, the tag reader 60 transmits overnight vehicle data, which contains the received information on a number plate, to the server 7.

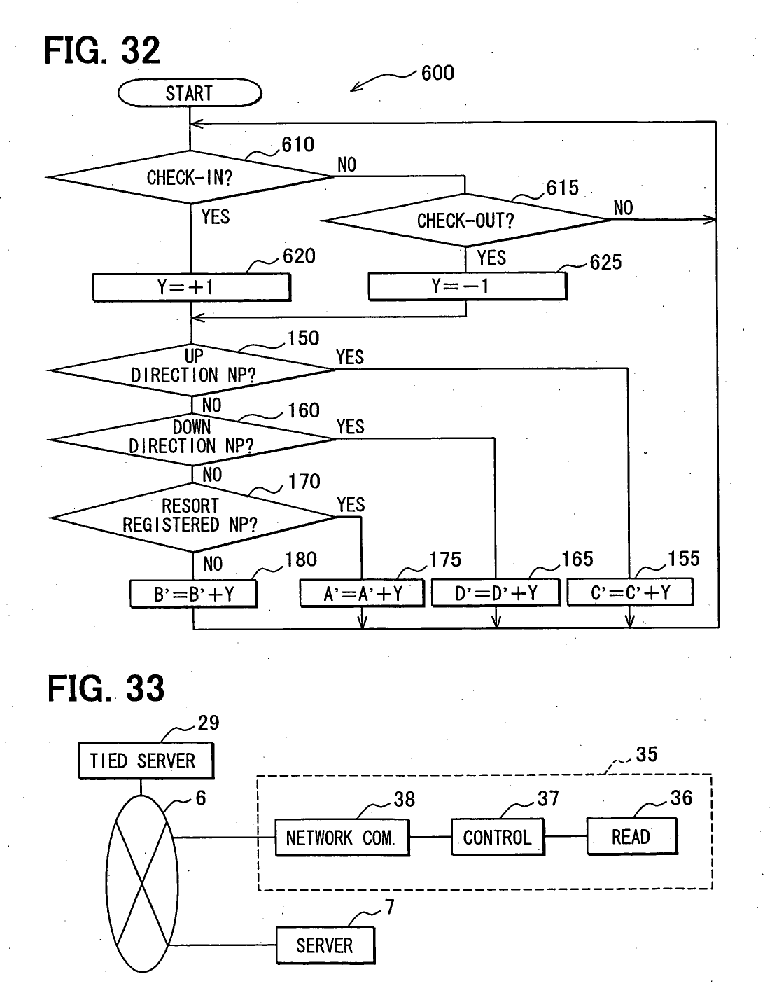

Moreover, the control unit 73 included in the server 7 employed in the present embodiment always runs a number-of-overnight vehicles count program 600 described in FIG. 32 in place of the number-of-overnight vehicles count program 500 employed in the fifth embodiment. At Step 610 and Step 615, the control unit 73 waits for check-in or check-out. When check-in is made, the value of a variable Y is set to 1 at Step 620. When check-out is made, the value of the variable Y is set to −1.

Whether check-in is made is verified based on whether overnight vehicle data is newly received from the check-in tag reader 60. Whether check-out is made is verified based on whether overnight vehicle data is newly received from the check-out tag reader 60.

For example, the check-in tag reader 60 may be installed in a guest room, and a guest may allow the check-in tag reader 60 to read information from his/her own handheld tag device. The check-out tag reader may be installed at a front desk. When the guest checks out, the guest may allow the check-out tag reader 60 to read information from his/her handheld tag device. Otherwise, both the check-in tag reader and check-out tag reader 60 may be installed at the front desk. An employee of an accommodation facility who is permitted to use a guest's handheld tag device may allow the respective tag readers 60 to read information from the guest's handheld tag device at the time of the guest's check-in and check-out.

Step 150 is executed subsequently to Step 620 or Step 625. The processing from Step 150 to Step 180 is identical to the one from Step 150 to Step 180 included in the number-of-overnight vehicles count program 500 described in FIG. 25. Step 610 is executed subsequently to Step 155, Step 165, Step 175, or Step 185.

As mentioned above, even when the number of vehicles in the premises of an accommodation facility is calculated based on pieces of information acquired from handheld tag devices, the same advantages as those of the fifth embodiment can be provided.

### SEVENTH EMBODIMENT

Next, the seventh embodiment of the present invention will be described. A difference of the present embodiment from the sixth embodiment is that when a reservation is made for accommodation at an accommodation facility within a resort 1, a server 7 increments by one the number of overnight vehicles in the resort 1 according to the reservation.

FIG. 33 is a conceptual diagram of a road traffic congestion degree estimation system in accordance with the present embodiment intended to realize the foregoing capability.

A credit card reader 35 installed at a travel agency or the like transmits information on a reservation for accommodation (containing a credit card number), which is acquired at the time of payment made using a credit card, to a server 7 stationed in an area associated with the reservation for accommodation. Based on the received information on the reservation for accommodation, the server 7 acquires information on a place name (a prefecture name or the like) retrieved from an address of an owner of a card, which has the credit card number contained in the information on the reservation for accommodation, from a tied server 29 connected on the network 6. The server 7 then increments by one the number of overnight vehicles according to whether the place name is found in the direction of the up lane of the expressway 3 or in the direction of the down lane thereof.

The credit card reader 35 comprises, as shown in FIG. 33, a read unit 36, a control unit 37, and a network communication unit 38.

The read unit 36 reads a credit card number or any other information from a credit card owned by a person having made a reservation, and transfers the credit card number to the control unit 37.

The network communication unit 38 manipulates data received from the control unit 37 in compliance with a communications protocol supported by a network 6, and transmits the resultant data to the server 7 over the network 6.

Responsively to a user's designation of an accommodation facility made at an operating device that is not shown, the control unit 37 transmits the credit card number received from the read unit 36 as information on a reservation for accommodation to the server 7, which is stationed in a resort 1 including the accommodation facility, via the network communication unit 38.

As mentioned above, the credit card reader 35 transmits information on a reservation for accommodation, which contains a credit card number, to the server 7 stationed in an area associated with an acquired name of an accommodation facility.

The tied server 29 is realized with an ordinary workstation or personal computer that has the ability to transmit or receive data over the network 6. The tied server 29 has data, which associates credit card numbers with addresses of the owners of the credit cards, stored in a storage medium such as a hard disk drive. When the tied server 29 receives data specifying a request for a place name associated with a certain credit card number over the network 6, the tied server 29 returns the place name, which is retrieved from an address associated with the credit card number specified in the request data, over the network 6.

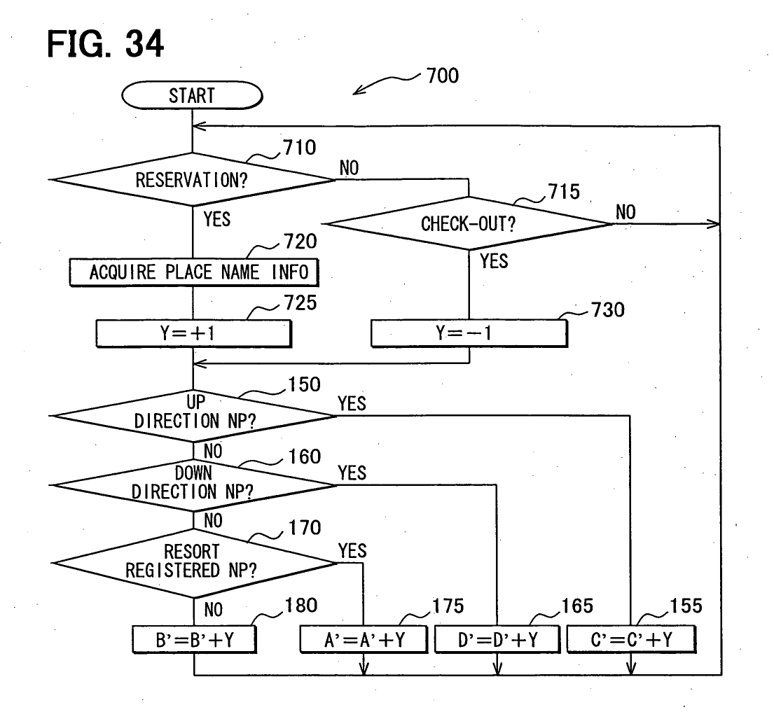

FIG. 34 is a flowchart describing a number-of-overnight vehicles count program 700 which the control unit 37 included in the server 7 employed in the present embodiment runs all the time. Along with the run of the number-of-overnight vehicles count program 700, the control unit 73 waits at Step 710 or Step 715 until a reservation for accommodation is taken or check-out is made. When a reservation for accommodation is taken, the control unit 73 acquires information on a place name from the tied server 29 at Step 720, and sets the value of a variable Y to 1 at Step 725. When check-out is made, the control unit 73 sets the value of the variable Y to −1 at Step 730.

Whether a reservation for accommodation is taken is verified based on whether information on a reservation for accommodation is newly received from the server 7. For information on a place name, data specifying a request for information on a place name, which contains a credit card number and which is included in the received information on a reservation for accommodation, is transmitted to the server 7. In response to the request, the server 7 returns the information on a place name. Moreover, whether check-out is made is, similarly to Step 615 included in the number-of-overnight vehicles count program 600 employed in the sixth embodiment, verified based on whether overnight vehicle data is newly received from the check-out tag reader 60.

Step 150 is executed subsequently to Step 725 or Step 730. The processing from Step 150 to Step 180 is identical to the one from Step 150 to Step 180 included in the number-of-overnight vehicles count program 600 described in FIG. 34. Step 710 is executed subsequently to Step 155, Step 165, Step 175, or Step 185.

As mentioned above, even when the number of vehicles in the premises of an accommodation facility is calculated based on reservations for accommodation, the same advantages as those of the fifth or sixth embodiment can be provided. According to the present embodiment, information on a reservation for accommodation is transmitted from the credit card reader, which reads information from a credit card, to the server 7. The present invention is not limited to this mode. Alternatively, a reservation for accommodation made at an Internet booking site or made through a Web browser by a user may be taken over a network. When the reservation is taken, a credit card number and information on an accommodation facility may be acquired. The credit card number may be transmitted as information on a reservation for accommodation to the server 7 stationed in an area where the accommodation facility is located.

Moreover, information on a reservation for accommodation sent from the credit card reader 35 to the server 7 may contain a scheduled date of accommodation entered by a user. In this case, the server 7 may increment by one the number of overnight vehicles according to a variable associated with a place name sent from the tied server 29 that retrieves the place name from an address associated with a credit card number used to make the reservation for accommodation on the scheduled date.

### EIGHTH EMBODIMENT

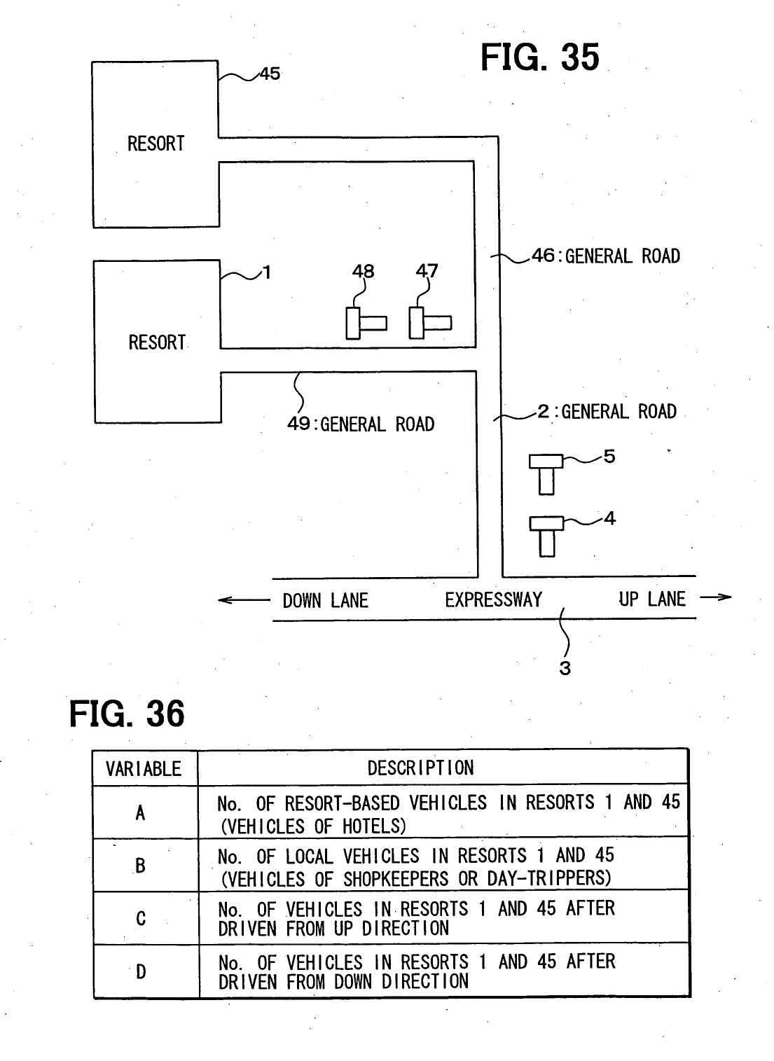

Next, the eighth embodiment of the present invention will be described. As the present embodiment, a road traffic congestion degree estimation system to be installed in an area which geomorphologically permits accesses to two resorts by way of one road will be described below. FIG. 35 is a bird's-eye view of an area near resorts where the road traffic congestion degree estimation system is installed.

In FIG. 35, a vehicle must leave an expressway 3 and enter a general road 2 so as to visit a resort 1 or a resort 45. Thereafter, the vehicle driven on the general road 2 enters a general road 46 so as to reach the resort 45. When the vehicle driven on the general road 2 enters a general road 49, the vehicle reaches the resort 1. According to the present embodiment, smart plate readers 4 and 5 are installed on the general road 2 leading to both the resorts 1 and 45, and smart plate readers 47 and 48 are installed on the general road 49 leading to the resort 1 alone. In this case, a smart plate reader need not be, as described later, installed on the general road 46 leading to the resort 45 alone.

A difference of the present embodiment from the first embodiment will be described below. The hardware configuration of the smart plate readers 4, 5, 47, and 48 is identical to that of the smart plate readers 4 and 5 included in the first embodiment.

Moreover, a control unit 73 included in a server 7 runs the number-of-vehicles count program 100 described in FIG. 7 for each pair of the smart plate readers 4 and 5, and the smart plate readers 47 and 48. As for the run of the number-of-vehicles count program 100 for the pair of the smart plate readers 47 and 48, FIG. 7 should be referred to with the description of the smart plate reader 4 replaced with the description of the smart plate reader 47 and the description of the smart plate reader 5 replaced with the description of the smart plate reader 48. Moreover, the descriptions of variables A, B, C, and D should be replaced with those of variables A1, B1, C1, and D1.

Consequently, as listed in the table of FIG. 36, the variable A signifies the sum total of resort-based vehicles currently existing in the resorts 1 and 45. The variable B signifies the sum total of local vehicles other than the resort-based vehicles currently existing in the resorts 1 and 45. The variable C signifies the sum total of vehicles currently existing in the resorts 1 and 45 after driven from the up direction. The variable D signifies the sum total of vehicles currently existing in the resorts 1 and 45 after driven from the down direction.

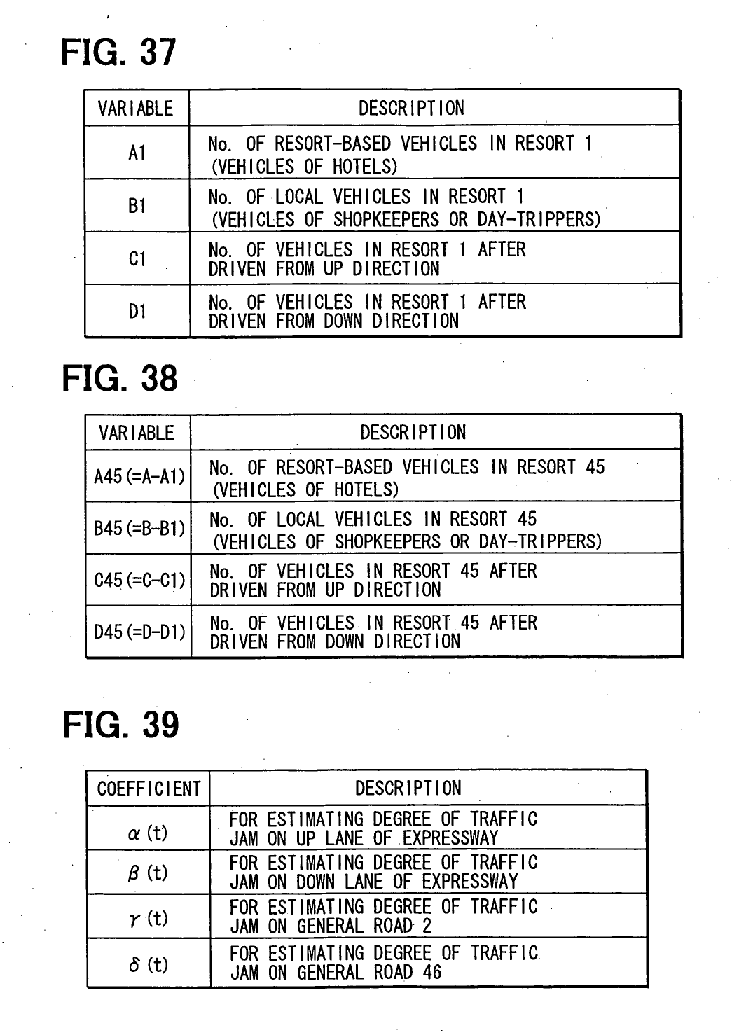

As listed in FIG. 37, the variable A1 signifies the number of resort-based vehicles currently existing in the resort 1. The variable B1 signifies the number of local vehicles other than the resort-based vehicles currently existing in the resort 1. The variable C1 signifies the number of vehicles currently existing in the resort 1 after driven from the up direction. The variable D1 signifies the number of vehicles currently existing in the resort 1 after driven from the down direction.

Consequently, as listed in FIG. 38, a value A45 calculated by subtracting the variable A1 from the variable A signifies the number of resort-based vehicles currently existing in the resort 45. A value B45 calculated by subtracting the variable B1 from the variable B signifies the number of local vehicles other than the resort-based vehicles currently existing in the resort 45. A value C45 calculated by subtracting the variable C1 from the variable C signifies the number of vehicles currently existing in the resort 45 after driven from the up direction. A value D45 calculated by subtracting the variable D1 from the variable D signifies the number of vehicles currently existing in the resort 45 after driven from the up direction.

Moreover, the control unit 73 uses four degree-of-traffic congestion coefficients α(t), β(t), γ(t), and δ(t) that are functions of a time instant t (ranging from 00:00 to 23:59) to run the degree-of-traffic congestion estimation program 200 described in FIG. 9. The coefficients α(t), β(t), γ(t), and δ(t) have the same dimension of (the degrees of traffic congestions/the numbers of vehicles) with respect to each of the up lane of the expressway 3, the down lane of the expressway 3, the general road 2, and the general road 46, as listed in FIG. 39.

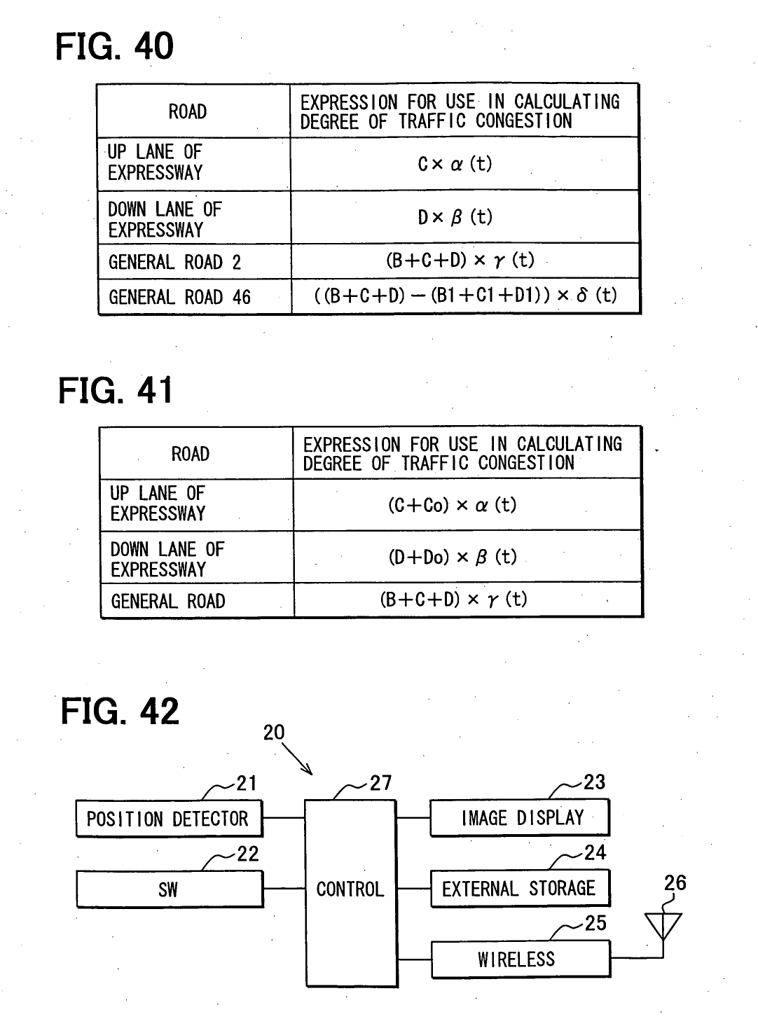

Expressions for use in calculating respective degrees of traffic congestions are listed in the table of FIG. 40. Specifically, a degree of traffic congestion at a time instant t on the up lane of the expressway 3 is a product of the variable C by the coefficient α(t). A degree of traffic congestion at the time instant t on the down lane of the expressway 3 is a product of the variable D by the coefficient β(t). A degree of traffic congestion at the time instant t on the general road 2 is a product of the sum of the variables B, C, and D by the coefficient γ(t). A degree of traffic congestion at the time instant t on the general road 46 is a product of the sum of the variables B45, C45, and D45 by the coefficient δ(t).

Consequently, although no smart plate reader is installed on the general road 46, the prospective degrees of traffic congestions on the general road 46, general road 2, and expressway 3 respectively can be estimated.

### NINTH EMBODIMENT

Next, the ninth embodiment of the present invention will be described. A difference of the present embodiment from the first embodiment is that expressions employed at Step 210 in the degree-of-traffic congestion estimation program 200 described in FIG. 9 are those listed in FIG. 41 but not those listed in FIG. 11.

The expressions for use in calculating respective degrees of traffic congestions employed in the present embodiment will be described below. Namely, a degree of traffic congestion at a time instant t on the up lane of an expressway 3 is a product of the sum of variables C and Co by a coefficient α(t). A degree of traffic congestion at the time instant t on the down lane of the expressway 3 is a product of the sum of variables D and Do by a coefficient β(t). Herein, the variable Co is an estimated value of a traffic volume near the junction between the down lane of the expressway 3 and a general road 2 at the time instant t at which a degree of traffic congestion is estimated. The variable Do is an estimated value of a traffic volume near the junction between the up lane of the expressway 3 and the general road 2 at the time instant t at which a degree of traffic congestion is estimated.

The estimated value may be a value statistically estimated based on previous drive records or a value inferred from the results of measurement of a traffic volume and directions of movements performed at any other place. Using the estimated value, a degree of traffic congestion can be estimated more highly precisely.

### TENTH EMBODIMENT

Next, the tenth embodiment of the present invention will be described. According to the present embodiment, a car navigation system mounted in a vehicle acquires data specifying an estimated degree of traffic congestion which a server 7 has produced and preserved, and displays an image according to the acquired estimated degree-of-traffic congestion data.

FIG. 42 shows the hardware configuration of a car navigation system 20 employed in the present embodiment. The car navigation system 20 comprises a position detector 21, a group of operating switches 22, an image display device 23, an external storage medium 24, a wireless unit 25, an antenna 26, and a control unit 27.

The position detector 21 includes a geomagnetic sensor, a gyroscope, a vehicle speed sensor, and a receiver that is a component of a global positioning system (GPS) that are not shown and that are already known. The position detector 21 transfers, to the control unit 27, pieces of information, which are specific to the natures of the sensors and used to identify the current position of a vehicle and the orientation thereof.

The group of operating switches 22 comprises multiple mechanical switches included in the car navigation system 20, and an input device such as a touch-sensitive panel placed on the display surface of the image display device 23. A signal produced responsively to a driver's press of a mechanical switch or a driver's touch of the touch-sensitive panel is transferred to the control unit 27.

The image display device 23 presents an image, which is displayed according to a video signal sent from the control unit 27, to the driver. The image to be displayed includes, for example, a map showing a current place in the center thereof.

The external storage medium 24 is a volatile storage medium such as a hard disk drive (HDD), a CD-ROM, or a DVD-ROM. Programs which the control unit 27 reads and runs and data representing a route guiding map are stored in the external storage medium 24.

The wireless unit 25 performs predetermined frequency conversion, demodulation, amplification, and analog-to-digital conversion on a signal received via the antenna 26, and transfers the resultant data to the control unit 27. Moreover, the wireless unit 25 performs predetermined digital-to-analog conversion, amplification, modulation, and frequency conversion on data received from the control unit 27, and transmits the resultant data via the antenna 26.

The control unit 27 includes a RAM, a ROM, and a CPU that are not shown. The CPU runs a program that is read from the ROM or external storage medium 24 and instructs the car navigation system 20 to perform actions. For the run of the program, the CPU reads information from the ROM, RAM, or external storage medium 24, writes information in the RAM or external storage medium 24, and transfers signals to or from the position detector 21, the group of operating switches 22, or the image display device 23.

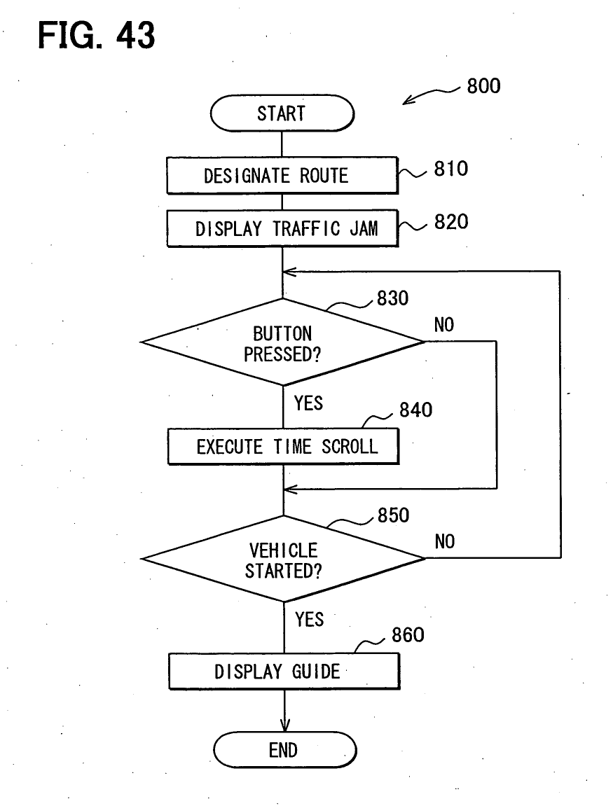

The control unit 27 receives data specifying an estimated degree of traffic congestion from the server 7 via the wireless unit 25, and stores the estimated degree-of-traffic congestion data in the external storage medium 24. Moreover, the control unit 27 runs a navigation program 800 described in FIG. 43 responsively to a user's manipulation performed on the group of operating switches 22 in order to enter a destination. At Step 810, a route from a current position identified by the position detector 21 to the entered destination is calculated.

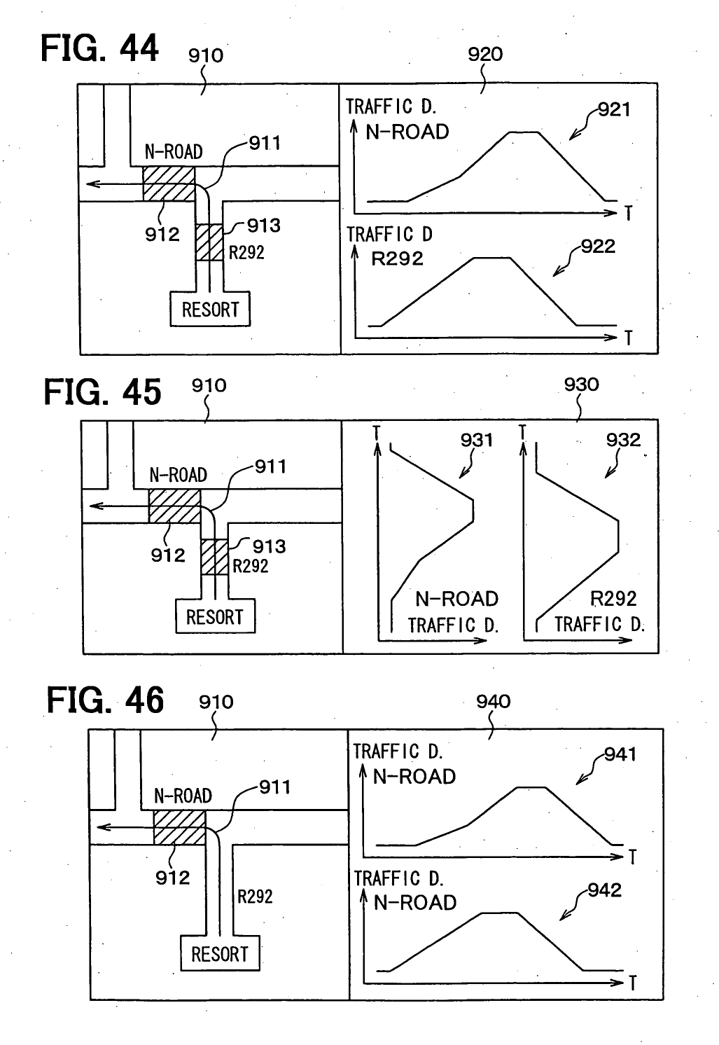

At Step 820, a screen image expressing a degree of road traffic congestion is displayed together with a map, which shows the calculated route, on the image display device 23. FIG. 44 to FIG. 46 show examples of the image to be displayed on the image display device 23 through the foregoing processing.

In the example shown in FIG. 44, the left-hand half of the display screen of the image display device 23 serves as a map display portion 910, and the right-hand half thereof serves as a graph display portion 920. A calculated route 911 is drawn on a map displayed on the map display portion 910. Parts of the map expressing traffic jams 912 and 913 on the route 911 are highlighted. The traffic jams are detected by calculating the positions of the traffic jams and the distances, by which the traffic jams extend, according to pieces of information on degrees of road traffic congestions acquired from the server 7 and then stored in the external storage medium 24.

Moreover, graphs 921 and 922 whose axes of abscissas indicate time instants and whose axes of ordinates indicate distances by which the respective traffic jams extend are displayed on the graph display portion 920. The time instants on the axis of abscissas are determined so that a time instant at which the vehicle driven along the route is expected to reach the position of the traffic jam will be indicated in the center of the axis of abscissas.

In the example shown in FIG. 45, graphs 931 and 932 whose axes of abscissas indicate distances by which the traffic jams 912 and 913 respectively extend and whose axes of ordinates indicate time instants are displayed on the graph display portion 930.

In the example shown in FIG. 46, graphs 941 and 942 whose axes of ordinates indicate distances by which the traffic jam 912 extends and whose axes of abscissas indicate time instants are displayed on the graph display portion 940. However, both the graphs 941 and 942 that are concerned with the one traffic jam 912 are displayed on the graph display portion 940. Herein, the graph 941 has the reading of the setout time instant of the vehicle at the leftmost end of the axis of abscissas, while the graph 942 has the reading of the time instant, at which the vehicle is expected to reach the traffic jam 912, in the center of the axis of abscissas.

Thus, the graphs demonstrate at what time instant the vehicle should set out so as to avoid a traffic jam occurring on an expressway.

In the aforesaid embodiments, the smart plate readers 4 and 5, the DSRC on-road machine 50, the wireless unit 74 included in the composite on-road machine 13, the DSRC wireless unit 76, and the ETC on-road machine 80 are equivalent to a vehicle sensor. Moreover, the server 7 is equivalent to a road traffic congestion degree estimation apparatus. Moreover, the smart plate reader 47 and smart plate reader 48 are equivalent to a parked vehicle sensor.

In the aforesaid embodiments, the general road 2 alone stretches between the resort 1 and the outside of the resort 1. However, the present embodiment is not limited to this situation. When multiple roads stretch between the resort 1 and the outside, the smart plate reader may be installed on all of the roads or may be installed on part of the roads. Even when the smart plate reader is installed on part of the roads, the prospective degree of traffic congestion on an expressway that joins the roads can be estimated moderately precisely. Moreover, the prospective degree of traffic congestion on an expressway that joins a road different from part of the roads on which the smart plate reader is installed can be moderately estimated as long as the inflow rate of vehicles from the part of the roads correlates with the degree of traffic congestion on the expressway at a subsequent time instant.

It will be obvious to those skilled in the art that various changes may be made in the above-described embodiments of the present invention. However, the scope of the present invention should be determined by the following claims.

What is claimed is:

1. A road traffic congestion degree estimation system comprising:
vehicle sensing means that detects a vehicle which is driven on a first road extending between a first area and an outside of the first area;
calculating means for calculating a number of local vehicles that are based in a second area including the first area and that currently exist in the first area and a number of strange vehicles that are based in an outside of the second area and currently exist in the first area, based on a number of approaching vehicles driven in a direction of approaching the first area and a number of receding vehicles driven on the first road in a direction of receding from the first area, wherein the number of approaching vehicles and the number of receding vehicles are included in a number of vehicles detected by the vehicle sensing means;
estimating means for estimating a prospective degree of traffic congestion on a second road, which extends from the second area to the outside of the second area and introduces a vehicle coming from the first area into the outside of the second area, based on the calculated number of strange vehicles and the calculated number of local vehicles, wherein the number of strange vehicles contributes more greatly to an increase in the degree of traffic congestion than the number of local vehicles contributes; and
storage control means for storing data, which specifies the estimated degree of traffic congestion, in a storage medium.

2. The road traffic congestion degree estimation system according to claim 1,
wherein the vehicle sensing means acquires pieces of information on number plates of the approaching vehicles driven on the first road and the receding vehicles driven on the first road, and
wherein the calculating means checks information on a place name, which is contained in the information on a number plate detected by the vehicle sensing means, to see whether a vehicle detected by the vehicle sensing means is a local vehicle or a strange vehicle.

3. The road traffic congestion degree estimation system according to claim 1,
wherein the vehicle sensing means includes a plurality of vehicle sensors that are installed on the first road, and
the calculating means checks an order in which the plurality of vehicle sensors detect a vehicle to see whether the vehicle is an approaching vehicle approaching the first area or a receding vehicle receding from the first area.

4. The road traffic congestion degree estimation system according to claim 1,
wherein the vehicle sensing means acquires information on a direction of drive in which a vehicle is driven on the first road or information on a scheduled drive route from a communication device mounted in the vehicle; and
the calculating means checks the acquired information on a direction of drive or the acquired information on a scheduled drive route to see whether the vehicle is an approaching vehicle approaching the first area or a receding vehicle receding from the first area.

5. The road traffic congestion degree estimation system according to claim 1, further comprising:
number-of-overnight vehicles calculating means for calculating numbers of strange vehicles and local vehicles which visit an accommodation facility located in the first area,
wherein the estimating means estimates the prospective degree of traffic congestion on the second road based on the calculated numbers of strange vehicles and local vehicles that visit the accommodation facility.

6. The road traffic congestion degree estimation system according to claim 5, further comprising:
a parked vehicle sensor that detects vehicles parked in the accommodation facility located in the first area and acquires pieces of information on number plates of the parked vehicles,
wherein the number-of-overnight vehicles calculating means calculates the numbers of strange vehicles and local vehicles, which visit the accommodation facility in the first area, based on a number of parked vehicles detected by the parked vehicle sensor and the acquired pieces of information on the number plates of the parked vehicles.

7. The road traffic congestion degree estimation system according to claim 5, further comprising:
a tag reader that is installed in the accommodation facility and that acquires pieces of information on number plates of vehicles from handheld tag devices in which the pieces of information on number plates are preserved,
wherein the number-of-overnight vehicles calculating means calculates the numbers of strange vehicles and local vehicles, which visit the accommodation facility, based on a number of vehicles identified with the acquired pieces of information on number.

8. The road traffic congestion degree estimation system according to claim 5, further comprising:
receiving means for taking a reservation for accommodation at the accommodation facility, and receiving information on an area, where a vehicle associated with the reservation for accommodation is based, from a tied server that transmits the information on an area over a communications network,
wherein the number-of-overnight vehicles calculating means calculates a numbers of strange vehicles and local vehicles, which visit the accommodation facility, based on the received information on an area.

9. A road traffic congestion degree estimation apparatus able to communicate with vehicle sensing means that detects a vehicle which is driven on a first road extending between a first area and an outside of the first area, the road traffic congestion degree estimation apparatus comprising:
calculating means for calculating a number of local vehicles that are based in a second area including the first area and that currently exist in the first area and a number of strange vehicles that are based in an outside of the second area and currently exist in the first area, based on a number of approaching vehicles driven in a direction of approaching the first area and a number of receding vehicles driven on the first road in a direction of receding from the first area, wherein the number of approaching vehicles and the number of receding vehicles are included in a number of vehicles detected by the vehicle sensing means;
estimating means for estimating a prospective degree of traffic congestion on a second road, which extends from the second area to the outside of the second area and introduces a vehicle coming from the first area into the outside of the second area, based on the calculated number of strange vehicles and the calculated number of local vehicles, wherein the number of strange vehicles contributes more greatly to an increase in the degree of traffic congestion than the number of local vehicles contributes; and
storage control means for storing data, which specifies the estimated degree of traffic congestion, in a storage medium.
